(19) United States
(12) Patent Application Publication
(10) Pub. No.: US 2026/0176527 A1
(43) Pub. Date: Jun. 25, 2026

(54) STABLE NANOCRYSTALS WITH NATIVE ALKOXY LIGANDS AND NEAR UNIVERSAL DISPERSIBILITY

(71) Applicant: The Board of Trustees of the University of Illinois, Urbana, IL (US)

(72) Inventors: Andrew M. SMITH, Savoy, IL (US); Suresh SARKAR, Champaign, IL (US)

(21) Appl. No.: 19/431,168

(22) Filed: Dec. 23, 2025

Related U.S. Application Data
(60) Provisional application No. 63/738,372, filed on Dec. 23, 2024.

(51) Int. Cl. C09K 11/88

(52) U.S. Cl. CPC C09K 11/883

(57) ABSTRACT

Syntheses of nanocrystals with nearly universal solvent dispersibility using ligands and solvents with alkoxy repeating units. Core syntheses, shell deposition, and cation exchange proceed similarly to traditional methods while products are more stable in aqueous solution than those generated by solvent transfer. The nanocrystals retain photoluminescence in cells for single particle tracking experiments and outperform other nanocrystal classes in diffusion metrics reflecting stability and resistance to nonspecific binding. Distinct reaction classes yield nanocrystals with either methoxy or hydroxy ligand terminations, both of which can be purified by aqueous methods that are chemically greener than traditional methods. These reactions can further generate nanocrystals with diverse oxide, sulfide, and selenide compositions, shapes, and spectral bands with wide dispersibility that may make applications in polar solvents more widely accessible.

### RELATED APPLICATIONS

The present application claims the benefit of U.S. Provisional Application No. 63/738,372, filed Dec. 23, 2024, the entire contents of which are incorporated herein by reference.

### STATEMENT REGARDING FEDERALLY SPONSORED RESEARCH OR DEVELOPMENT

This invention was made with government support under 1R01CA227699, 1R01EB032249, 1R01EB032725, and IR01GM131272 awarded by the National Institutes of Health, and under 2232681 and 2505928 awarded by the National Science Foundation. The government has certain rights in the invention.

### FIELD

The present disclosure relates to colloidal nanocrystals with alkoxy ligands and solvents. The present disclosure further relates to methods and systems used to synthesize colloidal nanocrystals with alkoxy ligands and solvents, enabling broad solvent dispersibility and enhanced stability in polar and aqueous media.

### BACKGROUND

Colloidal nanocrystals are commonly prepared by high-temperature reactions in mixtures of organic solvents and coordinating ligands. Nonpolar solvents, such as 1-octadecene, afford a broad temperature operating window to modulate precursor thermolysis, nucleation, and crystal growth. Long-chain fatty ligands such as oleic acid typically serve as surfactants to solubilize metal precursors and maintain dispersions in nonpolar media. Such organic-phase arrested-precipitation approaches have enabled the preparation of compositionally diverse nanomaterials and multi-component heterostructures through colloidal epitaxy and cation exchange, and have facilitated incorporation of nanocrystals into optoelectronic, catalytic, and biomedical systems.

Despite these advances, conventional alkyl-based syntheses present processing challenges when nanocrystals are required to be dispersed in polar environments. The long-chain hydrophobic ligands used to passivate nanocrystal surfaces hinder homogeneous dispersion in polar solvents, hydrogels, and many solid matrices, leading to aggregation and precipitation. This limitation complicates integration into conductive matrices and constrains applications that require aqueous or other polar dispersions.

To address the polarity mismatch, post-synthetic ligand exchange with polar ligands or encapsulation with amphiphilic coatings has been employed. These routes typically introduce multiple unit operations, can be difficult to scale, and may increase cost and solvent usage. Moreover, post-synthetic surface modification and changes in dispersion polarity can degrade nanocrystal performance due to surface etching, aggregation, and desorption of weakly bound coatings, resulting in reduced stability.

Accordingly, there remains a need for synthetic methods and reaction media that directly afford colloidal nanocrystals with robust dispersion in polar and aqueous media, that reduce or eliminate post-synthetic coating steps, that are compatible with scale-up, and that maintain or improve nanocrystal stability and functional properties.

### SUMMARY

The present disclosure provides methods for synthesizing colloidal nanocrystals that exhibit near-universal solvent dispersibility by employing ligands and solvents containing alkoxy repeating units (e.g., oligoethers). The approach addresses degradation and efficiency losses associated with polarity changes by enabling direct production of nanocrystals for use in solvents of opposite polarity without post-transfer deterioration.

In certain aspects, two reaction categories are disclosed that produce nanocrystals bearing alkoxy ligands with either methoxy or hydroxy terminations. Substituting traditional alkyl reagents with alkoxy reagents enables aqueous purification workflows that are greener and potentially more scalable. The reactions provide access to diverse shapes and compositions with broad photophysical properties and wide dispersibility, thereby improving production efficiency and facilitating applications in polar solvents.

In one exemplary embodiment according to the present disclosure, a method of making nanocrystals is described. The method may comprise a step of providing a reaction system comprising, consisting of, or consisting essentially of at least one metal precursor, at least one alkoxy ligand, and at least one alkoxy solvent. The method may further comprise heating the reaction system to a temperature effective to form the nanocrystals. In certain embodiments, the temperature effective to form the nanocrystals may range from about 100° C. to about 380° C.

In some embodiments, the reaction system further comprises a chalcogen precursor. In further embodiments, the reaction system consists of or consists essentially of the at least one metal precursor, the at least one alkoxy ligand, the at least one alkoxy solvent, and the chalcogen precursor. The chalcogen precursor may be selected from selenium, selenium dioxide, sulfur, bis(trimethylsilyl) sulfide, a thiourea, and a selenourea. The selenourea may comprise N,N′-di(2-methoxyethyl)-N-methylselenourea. The thiourea may comprise N,N′-di(2-methoxyethyl)-N-methylthiourea. The chalcogen precursor may also be the same as the alkoxy ligand and may include poly(ethylene glycol) monothiol monohydroxy or poly(ethylene glycol) monothiol monomethyl ether.

In certain implementations, the metal precursor is selected from cadmium acetate, cadmium oxide, cadmium chloride, cadmium myristate, cadmium behenate, lead(II) acetate trihydrate, lead(II) chloride, lead oxide, lead(II) acetate, silver acetate, copper acetate, zinc acetate, zinc oxide, and cadmium chloride monohydrate.

The alkoxy ligand may, in some implementations, include an oligo(ethylene glycol) compound, polyethylene glycol, ethylene glycol, propylene glycol, a dihydroxy-terminated triethylene glycol, and a dimethoxy-terminated triethylene glycol. The oligo(ethylene glycol) compound may be terminated with a functional group selected from methoxy, alcohol, thiol, amine, carboxylic acid, phosphonic acid, phosphoric acid, and phosphine. The alkoxy ligand may also be selected from poly(ethylene glycol) monothiol monomethyl ether, poly(ethylene glycol) monothiol monoacid, poly(ethylene glycol) monothiol monohydroxy, poly(ethylene glycol) monoacid monomethyl ether, poly(ethylene glycol) diacid, and α-hydroxy-ω-propionic acid tetraethylene glycol.

The alkoxy solvent may be selected from a tertiary amine alkoxy solvent and a dihydroxy alkoxy solvent. The alkoxy solvent may also be selected from tris[2-(2-methoxyethoxy)ethyl]amine, tetraethylene glycol, poly(ethylene glycol) dimethyl ether, poly(ethylene glycol) monohydroxy monomethyl ether, and poly(propylene glycol) mono-2-aminopropyl monomethoxyethyl.

Once formed, the nanocrystals may be dispersible at room temperature in a solvent having a dielectric constant (F) from about 2.4 to about 182. In some aspects, the nanocrystals are, or may be used to form, quantum dots having a quantum yield from about 10% to about 90% when dispersed in the solvent at room temperature.

In certain implementations, the nanocrystals may comprise CdSe, CdS, CdSeS, PbS, PbSe, Ag₂S, Cu₂S, Ag₂Se, ZnO, CdO, CdSe nanoplatelets, (CdSe)CdS nanorods, (CdSe)CdZnS core/shell nanocrystals, (CdSeS)CdS core/shell nanocrystals, (PbS)CdS core/shell nanocrystals, or any combination thereof. The method may further comprise growing a shell on the nanocrystals, the shell selected from CdS, ZnSe, ZnS, CdZnSe, CdZnS, or combinations thereof. The shell may comprise a multi-layer architecture selected from CdS/ZnS, CdS/CdZnS, CdZnS/ZnS, ZnSe/ZnS, CdZnSe/ZnSe, CdZnSe/ZnS, or repeated layer-by-layer sequences and the nanocrystals may have cores comprising CdS, Cu₂S, Ag₂S, PbS, Ag₂Se, PbSe, CdSe, CdSeS, or any combination thereof. In some examples, the nanocrystals have a diameter from about 2 nm to about 20 nm.

In some examples, the reaction system comprises a methoxy-terminated alkoxy ligand and a methoxy-terminated alkoxy solvent. In some examples, the reaction system comprises a polar-terminated alkoxy ligands and a dihydroxy-terminated alkoxy solvent.

In some aspects, the reaction system is free or substantially free of alkyl ligands. In some examples, the reaction system is free or substantially free of alkyl solvents. In some examples, the reaction system is free or substantially free of alkyl ligands and alkyl solvents. In certain embodiments, the reaction system does not include 1-dodecanethiol or oleic acid. In some embodiments, the reaction system does not include 1-octadecene (ODE), oleylamine (OLA), oleic acid, trioctylphosphine (TOP), or trioctylphosphine oxide (TOPO).

The methods support core synthesis, epitaxial shell deposition, and cation exchange, yielding products that are substantially more stable in aqueous environments than nanocrystals transferred to water after nonpolar synthesis. In representative embodiments with fluorescent (CdSe)CdZnS nanocrystals, the products retain bright emission in living cells and outperform other classes in diffusion metrics indicative of stability and resistance to nonspecific binding.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows an example of a comparative schematic of ligands and solvents used in alkyl and alkoxy reaction systems for nanocrystal synthesis according to aspects of the present disclosure.

FIG. 2 shows an example of solvent dispersibility, hydrodynamic diameter distribution, and polymer matrix compatibility of nanocrystals synthesized using alkyl and alkoxy reaction systems according to aspects of the present disclosure.

FIG. 3 shows an example of purification processes for nanocrystals synthesized via alkoxy reactions, including precipitation from polar and nonpolar solvents and filtration through molecular weight cutoff membranes according to aspects of the present disclosure.

FIG. 4 shows an example of a comparative analysis of nanocrystals synthesized using alkoxy-based reactions (NC-1) versus alkyl-based reactions with post-synthetic modifications (NC-2a, NC-2b, NC-2c), highlighting differences in stability, ligand binding, and intracellular behavior according to aspects of the present disclosure.

FIG. 5 shows synthesis and photophysical characterization of nanocrystals with diverse shapes and compositions, including quasi-spherical, rod-shaped, and platelet structures, using alkoxy-based reactions according to aspects of the present disclosure.

FIG. 6 shows absorbance and photoluminescence spectra alongside transmission electron microscopy (TEM) images of diverse nanocrystals synthesized using alkoxy reactions, showcasing their compositions, sizes, and structural uniformity in accordance with aspects of the present disclosure.

FIG. 7 shows, in part a, absorbance spectra and, in, part b, a zoomed-in band-edge region, and, in part c, photoluminescence spectra during stepwise shell growth on CdSe nanocrystals, showing changes in optical properties with increasing monolayers of CdS according to aspects of the present disclosure.

FIG. 8 shows, in parts a-c, high-resolution transmission electron micrographs and, in part d, a size histogram of (CdSe)CdZnS nanocrystals synthesized using methoxy-terminated alkoxy shell growth reactions according to aspects of the present disclosure.

FIG. 9 shows transmission electron micrographs of (CdSe)CdZnS nanocrystals demonstrating their homogeneous dispersion across solvents with varying polarities according to aspects of the present disclosure.

FIG. 10 shows cytotoxicity measurements of alkoxy reaction components and traditional phase transfer agents using HeLa cell viability assays according to aspects of the present disclosure.

FIG. 11 shows, ¹H Nuclear Magnetic Resonance (NMR) spectra comparing ligand 1a, NC-1, and NC-2a, highlighting chemical shifts and residual impurities according to aspects of the present disclosure.

FIG. 12 shows diffusion-ordered NMR spectroscopy (DOSY) data comparing the diffusion coefficients of ligand 1a and NC-1 in deuterated chloroform according to aspects of the present disclosure.

FIG. 13 shows sulfur 2p X-ray photoelectron spectra comparing CdS nanocrystals synthesized using 1-dodecanethiol and elemental sulfur as precursors according to aspects of the present disclosure.

FIG. 14 shows comparative diffusion metrics and mobility analysis of NC-1, NC-2a, and NC-2b nanocrystals in living cells according to aspects of the present disclosure.

FIG. 15 shows dynamic single-particle fluorescence microscopy and tracking of nanocrystals in living cells, showing trajectories and diffusion metrics according to aspects of the present disclosure.

FIG. 16 shows dynamic single-particle fluorescence microscopy and tracking metrics for nanocrystals in living cells, including trajectories, diffusion coefficients, mean squared displacement, and mobile fraction analysis according to aspects of the present disclosure.

FIG. 17 shows absorbance and photoluminescence spectra of PbS and (PbS)CdS nanocrystals, alongside transmission electron micrographs confirming their uniform size and morphology according to aspects of the present disclosure.

FIG. 18 shows absorbance and photoluminescence spectra and transmission electron microscopy images of (CdSe)CdS and (CdSe)CdS/CdS nanorods, highlighting their optical properties and structural morphology according to aspects of the present disclosure.

FIG. 19 shows absorbance and photoluminescence spectra and transmission electron micrographs of (CdSe)CdS nanorods before and after shell growth in alkoxy reactions according to aspects of the present disclosure.

FIG. 20 shows transmission electron micrographs and absorbance and photoluminescence spectra of nanocrystals synthesized using alkoxy-based reactions according to aspects of the present disclosure.

FIG. 21 shows a transmission electron micrograph depicting the very small and uniform size distribution of nanocrystals synthesized using alkoxy-based methods according to aspects of the present disclosure.

FIG. 22 shows dynamic single-particle fluorescence microscopy and tracking metrics for nanocrystals in living cells, including trajectories, diffusion coefficients, mean squared displacement, and mobile fraction analysis according to aspects of the present disclosure.

FIG. 23 shows chemical functionalization and transformation of NC-3a nanocrystals into NC-3b through base treatment, including Fourier Transform Infrared (FT-IR) spectra, gel electrophoresis, and chromatographic analysis according to aspects of the present disclosure.

FIG. 24 shows FT-IR spectra of NC-1 and ligand 1a, indicating ether bands and absence of esters (˜1750 cm⁻¹), hydroxyls (˜3400 cm⁻¹), and methyls (˜3000 cm⁻¹), with residual adsorbed water following aqueous purification according to aspects of the present disclosure.

FIG. 25 shows FT-IR spectra of NC-3a and NC-3b, where NC-3a exhibits hydroxyls, esters, and methyl groups, and NC-3b shows ester conversion to carboxylic acids with disappearance of methyl bands, with water remaining adsorbed in both samples according to aspects of the present disclosure.

FIG. 26 shows FT-IR spectra of a reaction system comprising solvent 3b and ligand 2b chelating Cd²⁺ at 220° C., including time-resolved and difference spectra evidencing ester formation with depletion of carboxylic acids and hydroxyls, increases in non-methoxy methyl and CdO bands, and reference spectra of 3b, 2b, and the 2b-chelated Cd²⁺ complex according to aspects of the present disclosure.

FIG. 27 shows, in parts a and b, normalized absorbance and photoluminescence spectra during stepwise shell growth of CdSe/ZnSe/ZnS quantum dots, and in part c, quantum yield enhancements according to aspects of the present disclosure.

FIG. 28 shows, in, part a, XRD patterns and, in, part b, TEM images of CdSe/ZnSe/ZnS quantum dots during shell growth, confirming structural integrity and uniform size distribution according to aspects of the present disclosure.

FIG. 29 shows, in, part a, optical spectra, in part b, Fast Protein Liquid Chromatography (FPLC) elution profiles, and in, part c, emission peak shifts with varying Methoxy-Polyethylene Glycol-Thiol (mPEG-SH) molecular weights for Zn-doped Ag₂S nanocrystals according to aspects of the present disclosure.

FIG. 30 shows transmission electron microscopy (TEM) images of nanocrystals synthesized using alkoxy-based reactions, demonstrating uniform size distribution and high crystallinity according to aspects of the present disclosure.

### DETAILED DESCRIPTION

Certain aspects of the present disclosure relate to nanocrystal synthesis using ligands and solvents with alkoxy repeating units (e.g., oligoethers) to achieve homogeneous dispersion in both polar and nonpolar media. The methods allow for core synthesis, epitaxial shell deposition, and cation exchange, and yield products that are substantially more stable in aqueous solution than nanocrystals transferred to water after nonpolar synthesis. Two reaction categories may be provided to generate nanocrystals bearing ligands with either methoxy or hydroxy terminations.

In representative embodiments with fluorescent (CdSe)CdZnS (core)shell particles, the products may fully disperse across a wide solvent range, retain bright emission in living cells for single-molecule tracking, and outperform other nanocrystal classes in diffusion metrics indicative of stability and resistance to nonspecific binding. The replacement of traditional alkyl reagents with alkoxy reagents further allows greener, potentially more scalable aqueous purification via filtration, salting out, and chromatography, while accessing diverse shapes, compositions, and photophysical properties.

In certain embodiments, alkoxy-based synthesis reactions produce colloidal nanocrystals exhibiting broad solvent dispersibility that is not achievable using conventional alkyl-based methods. In particular, the disclosed reactions allow for immediate and homogeneous dispersion in polar and aqueous media, thereby simplifying production workflows for nanomaterials intended for biomedical applications and polar-phase catalysis and facilitating long-term stability in aqueous environments. The reaction system may be compatible with a wide variety of alkoxy compounds, including glymes and polyethers such as oligo(ethylene glycol) and poly(ethylene glycol), which may provide tunable viscosities and boiling points.

In some implementations, the reagents are comparatively environmentally benign relative to reagents used for alkyl-based synthesis and surface modification and permit workup using aqueous solvents. By avoiding the need for post-synthesis coating steps, the disclosed methods can reduce scale-up bottlenecks and improve product quality, stability, and batch-to-batch consistency of aggregation-free nanocrystals in polar media. The reaction platform supports nanocrystal core syntheses, heteroepitaxial shell growth, and cation exchange, and is applicable across a range of chemical compositions, particle shapes, and emission bands. The approach is generalizable to additional compositions and heterostructure families that have previously been prepared by alkyl-based synthesis routes.

In one exemplary embodiment according to the present disclosure, a method of making nanocrystals is described. As used herein, “nanocrystals” means crystalline inorganic particles having at least one dimension in the nanometer scale, and encompassing anisotropic shapes such as rods, platelets, and core/shell heterostructures.

The method may comprise a step of providing a reaction system comprising, consisting of, or consisting essentially of, at least one metal precursor, at least one alkoxy ligand, and at least one alkoxy solvent.

As used herein, “metal precursor” means a compound that provides a metal cation for nanocrystal formation or growth, including, without limitation, cadmium acetate, cadmium oxide, cadmium chloride, cadmium myristate, cadmium behenate, lead(II) acetate trihydrate, lead(II) chloride, lead oxide, lead(II) acetate, silver acetate, copper acetate, zinc acetate, zinc oxide, and cadmium chloride monohydrate. In additional embodiments, suitable metal precursors may include nitrates, sulfates, halides, carboxylates, and organometallic complexes of Group 12-16 metals and transition metals, such as zinc nitrate, copper(II) chloride, silver nitrate, indium(III) acetate, gallium(III) nitrate, tin(II) acetate, tin(IV) chloride, bismuth(III) nitrate, manganese(II) acetate, cobalt(II) acetate, nickel(II) acetylacetonate, iron(III) acetylacetonate, titanium(IV) isopropoxide, zirconium(IV) propoxide, and hafnium(IV) chloride, as well as mixed-metal salts or complexes that provide multiple cations for alloy or doped nanocrystal formation.

An “alkoxy ligand” means an organic ligand containing one or more alkoxy repeating units (e.g., oligoethers such as oligo(ethylene glycol) or poly(ethylene glycol)) and a terminal coordinating group configured to bind to a nanocrystal surface, the terminal group being selected from methoxy, alcohol, thiol, amine, and carboxylic acid, phosphonic acid, phosphoric acid, and phosphine. Non-limiting examples include poly(ethylene glycol) monothiol monomethyl ether, poly(ethylene glycol) monothiol monoacid, poly(ethylene glycol) monothiol monohydroxy, poly(ethylene glycol) monoacid monomethyl ether, poly(ethylene glycol) diacid, and α-hydroxy-ω-propionic acid tetraethylene glycol. In additional embodiments, suitable alkoxy ligands may include oligo(propylene glycol) analogs and mixed-backbone polyethers bearing coordinating termini, such as methoxy-terminated oligo(ethylene glycol) amines, hydroxy-terminated oligo(propylene glycol) thiols, carboxy-terminated glycolic acid-modified PEG, PEG-bis(amine), PEG-bis(thiol), and PEG-phosphonic acid derivatives, as well as block copolymers comprising poly(ethylene glycol) segments with terminal coordinating groups selected from phosphonic acid, sulfonic acid, imidazole, pyridine, or catechol. These alternatives can be selected to tune ligand binding strength, steric profile, and dispersion polarity while maintaining alkoxy repeat units along the backbone.

An “alkoxy solvent” means a solvent with sufficient polarity to solubilize alkoxy ligands and precursors and stabilize the dispersion during synthesis and growth, and a boiling point that is sufficiently high to allow nanocrystal synthesis. The alkoxy solvent may include molecules bearing alkoxy repeating units, including, without limitation, tertiary amine alkoxy solvents and dihydroxy alkoxy solvents such as tris[2-(2-methoxyethoxy)ethyl]amine, tetraethylene glycol, poly(ethylene glycol) dimethyl ether, poly(ethylene glycol) monohydroxy monomethyl ether, and poly(propylene glycol) mono-2-aminopropyl monomethoxyethyl. In additional embodiments, suitable alkoxy solvents may include glymes and higher polyethers and mixed-backbone ethers, such as diethylene glycol dimethyl ether, triethylene glycol dimethyl ether, tetraglyme, polyethylene glycol methyl ether variants spanning about 200-2000 Da, polypropylene glycol methyl ether variants, 2-(2-methoxyethoxy)ethanol, N-methoxyethylated amines, and ether-functional ionic liquids or deep eutectic solvents bearing alkoxy chains. Coordinating co-solvents containing alkoxy groups, including methoxy-terminated polyethers with primary or secondary amines, imidazoles, or pyridines, may also be employed to modulate boiling point, viscosity, and Lewis basicity while maintaining alkoxy repeat units in the solvent backbone.

The method may further comprise heating the reaction system to a temperature effective to form the nanocrystals. In certain embodiments, the temperature effective to form the nanocrystals may range from about 100° C. to about 380° C., including any subranges therein, such as from about 100° C. to about 150° C., from about 150° C. to about 190° C., from about 190° C. to about 220° C., from about 220° C. to about 260° C., from about 260° C. to about 300° C., from about 300° C. to about 340° C., and from about 340° C. to about 380° C.; further exemplary nested subranges include from about 120° C. to about 180° C., from about 130° C. to about 210° C., from about 160° C. to about 240° C., from about 200° C. to about 280° C., and from about 240° C. to about 320° C. In related embodiments, narrower temperature windows within any of the foregoing ranges may be employed, for example from about 170° C. to about 190° C., from about 205° C. to about 225° C., from about 215° C. to about 235° C., or from about 350° C. to about 370° C., depending on precursor identity, ligand composition, solvent polarity, and desired nanocrystal morphology.

Once formed, the nanocrystals may be dispersible at room temperature in a solvent having a room temperature dielectric constant (F) from about 2.4 to about 182 (i.e., near universal dispersability), including any subranges therein, such as from about 2.4 to about 10 (low-polarity media, for example toluene, ε≈2.4, and chloroform, ε≈4.8), from about 10 to about 40 (moderately polar media, for example 1,2-dichloroethane, ε≈10.4, acetone, ε≈20.7, ethanol, ε≈24.3, and acetonitrile, ε≈36), from about 40 to about 80 (high-polarity media, for example dimethyl sulfoxide, ε≈46.7, and dimethylformamide, ε≈36.7), and from about 80 to about 182 (very high-polarity media, for example water, ε≈78.5, and N-methylformamide, ε≈182). In related embodiments, dispersability is demonstrated in at least one solvent in each of the foregoing subranges. In some embodiments, non-solvents for purification, such as hexane (ε≈1.9) and diethyl ether (ε≈4.3), are excluded from the set of dispersible media.

As defined herein, “room temperature” is from about 20-30° C. including all subranges, such as, but not limited to, from about 20-22° C., from about 22-24° C., from about 24-26° C., from about 26-28° C., and from about 28-30° C., as well as narrower windows including from about 20-21° C., from about 21-23° C., from about 23-25° C., from about 25-27° C., and from about 27-29° C., and any individual values within 20-30° C. (e.g., about 20° C., about 21° C., about 22° C., about 23° C., about 24° C., about 25° C., about 26° C., about 27° C., about 28° C., about 29° C., or about 30° C.).

As used herein, “dispersible” and similar terms like “dispersibility” mean that, at room temperature and at an analytically convenient concentration (for example about 0.5-5 μM nanocrystals or about 0.05-1 mg mL⁻¹), the nanocrystals form a single-phase dispersion that remains visibly free of precipitate for at least 24 hours and meets at least one, at least, two, at least three, or at least four, of the following quantitative criteria: (i) number-weighted dynamic light scattering shows a unimodal hydrodynamic diameter consistent with the expected core-plus-ligand size (for example within about ±20%) with a polydispersity index of about 0.20 or less; (ii) ultraviolet-visible absorbance exhibits resolvable features of electronic transitions without an upturn from scattering at long wavelengths; (iii) transmission electron microscopy of drop-cast samples shows isolated particles without large-area agglomerates; and/or (iv) photoluminescence is retained with an emission peak position within about ±5 nm of that measured in a reference solvent and a quantum yield of at least about 5% or within about ±20% of the value measured in a low-polarity solvent.

In some aspects, the nanocrystals are, or may be used to form, quantum dots. As used herein, “quantum dots” means semiconductor nanocrystals that exhibit quantum confinement effects such that their optical absorption and photoluminescence are tunable with size, shape, and composition. As used herein, “quantum yield” means the ratio of photons emitted to photons absorbed under defined excitation conditions, expressed as a percentage. When dispersed in the solvent at room temperature (as defined above), the quantum dots have a quantum yield from about 10% to about 90%, including any subranges therein, such as from about 10% to about 20%, from about 15% to about 30%, from about 20% to about 40%, from about 25% to about 50%, from about 30% to about 60%, from about 40% to about 70%, and from about 75% to about 90%; further exemplary nested subranges include from about 12% to about 18%, from about 18% to about 28%, from about 22% to about 38%, from about 35% to about 55%, from about 45% to about 65%, from about 55% to about 75%, and from about 75% to about 85%. In certain non-limiting embodiments, the quantum yield is at least about 10%, at least about 20%, at least about 30%, at least about 40%, at least about 50%, at least about 60%, at least about 70%, or at least about 80%.

In some embodiments, the reaction system further comprises a chalcogen precursor. In some aspects, the reaction system consists of or consists essentially of the at least one metal precursor, the at least one alkoxy ligand, the at least one alkoxy solvent, and the at least one chalcogen precursor.

As used herein, “chalcogen precursor” means a compound that supplies a chalcogen element selected from oxygen, sulfur, selenium, or tellurium to the reaction mixture in a reactive form suitable for nanocrystal nucleation, growth, shell deposition, or oxide formation. Non-limiting examples include elemental sulfur and selenium, selenium dioxide, sulfur dioxide, bis(trimethylsilyl) sulfide, thiourea derivatives (for example N,N′-di(2-methoxyethyl)-N-methylthiourea), and selenourea derivatives (for example N,N′-di(2-methoxyethyl)-N-methylselenourea). In certain embodiments, the chalcogen precursor may be provided by an alkoxy ligand bearing a chalcogen-donating terminal group, such as poly(ethylene glycol) monothiol monohydroxy or poly(ethylene glycol) monothiol monomethyl ether. Additional non-limiting examples of chalcogen precursors include hydrogen sulfide, hydrogen selenide, sodium hydrosulfide, sodium selenide, thioglycolic acid, thioacetamide, trioctylphosphine sulfide, trioctylphosphine selenide, diethyl selenide, diethyl telluride, tellurium dioxide, and bis(trimethylsilyl) selenide.

In certain implementations, the nanocrystals may comprise CdSe, CdS, CdSeS, PbS, PbSe, Ag₂S, Cu₂S, Ag₂Se, ZnO, CdO, CdSe nanoplatelets, (CdSe)CdS nanorods, (CdSe)CdZnS core/shell nanocrystals, (CdSeS)CdS core/shell nanocrystals, (PbS)CdS core/shell nanocrystals, or any combination thereof. In some embodiments, the nanocrystals may further include other compositions such as ZnS, ZnSe, CdTe, PbTe, InP, InAs, GaAs, GaN, or doped variants thereof. The method may further comprise growing a shell on the nanocrystals, the shell selected from CdS, ZnS, CdZnS, or any combination thereof, and in certain embodiments further including ZnSe, CdSe, or gradient alloys. The shell may comprise a multi-layer architecture selected from CdS/ZnS, CdS/CdZnS, CdZnS/ZnS, CdZnSe/ZnSe, CdZnSe/ZnS, ZnSeS/ZnS, or repeated layer-by-layer sequences. In certain embodiments, the nanocrystals may have cores comprising CdS, Cu₂S, Ag₂S, PbS, Ag₂Se, PbSe, CdSe, or CdSeS. In some embodiments, the nanocrystals may further comprise cores of ZnS, ZnSe, CdTe, PbTe, InP, InAs, GaAs, GaN, or any combination thereof.

In some examples, the nanocrystals have a diameter from about 2 nm to about 20 nm. As used herein, “diameter” means a characteristic particle size measured on the nanocrystal population by one or more conventional materials characterization methods and defined according to particle morphology: for quasi-spherical particles, diameter refers to the number-weighted mean of the maximum Feret dimension observed by transmission electron microscopy (TEM) or the core size inferred from electronic transitions in ultraviolet-visible absorbance; for anisotropic particles such as rods or platelets, diameter refers to the lateral dimension perpendicular to the principal axis (for rods) or to thickness or lateral edge length as specified for platelets, and may be reported alongside length for rods or thickness for platelets. Diameter may additionally be determined as a solvodynamic or hydrodynamic diameter by dynamic light scattering (DLS) from number-based distributions, by diffusion-ordered nuclear magnetic resonance spectroscopy (DOSY) via the Stokes-Einstein relationship, or by gel permeation chromatography (GPC) elution calibrated to size standards; in certain embodiments, values derived from these techniques are reported with the method used and distribution type (number, volume, or intensity). Diameter values may be expressed as mean±standard deviation or as a percentile interval and may be corroborated across two or more of TEM, DLS, DOSY, absorbance-based sizing, and GPC.

In certain non-limiting embodiments, the diameter is within any of the following subranges: from about 2 nm to about 6 nm, from about 3 nm to about 8 nm, from about 4 nm to about 10 nm, from about 5 nm to about 12 nm, from about 6 nm to about 15 nm, and from about 8 nm to about 20 nm; further exemplary nested subranges include from about 2.5 nm to about 4.5 nm, from about 4.5 nm to about 6.5 nm, from about 6.5 nm to about 9.5 nm, and from about 9.5 nm to about 13.5 nm. In related embodiments, broader size ranges are contemplated, for example from about 1 nm to about 100 nm, including any subranges therein such as from about 1 nm to about 5 nm, from about 5 nm to about 15 nm, from about 10 nm to about 30 nm, from about 20 nm to about 50 nm, and from about 50 nm to about 100 nm.

In some examples, the reaction system comprises a methoxy-terminated alkoxy ligand and a methoxy-terminated alkoxy solvent. As used herein, “methoxy-terminated” refers to reaction components in which at least one terminal functional group on the ligand and solvent is a methoxy group (—OCH₃), providing relatively low polarity and diminished hydrogen-bonding compared with hydroxyl termini, thereby allowing for colloidal stability at elevated temperatures in ether-rich media and facilitating controlled epitaxial growth. In certain embodiments, the methoxy-terminated alkoxy ligand is an oligo(ethylene glycol) or oligo(propylene glycol) derivative bearing a coordinating group toward the nanocrystal surface and a distal methoxy terminus, for example poly(ethylene glycol) monothiol monomethyl ether, poly(ethylene glycol) monoacid monomethyl ether, methoxy-terminated oligo(ethylene glycol) amines, or methoxy-terminated oligo(ethylene glycol) phosphonic acids.

In related embodiments, the methoxy-terminated alkoxy solvent is selected from tris[2-(2-methoxyethoxy)ethyl]amine, poly(ethylene glycol) dimethyl ether, poly(ethylene glycol) monohydroxy monomethyl ether, and mono-amine poly(propylene glycol) monomethoxyethyl, and may further include dimethoxy-terminated glymes such as triethylene glycol dimethyl ether or tetraglyme to tune viscosity, boiling point, and Lewis basicity. In certain implementations, the methoxy-terminated class is applied for shell growth using thiol-based sulfur precursors, where the solvent provides L-type coordination (for example tertiary or primary amines) and the ligand set maintains dispersion while permitting ligand cleavage to generate sulfides; exemplary methoxy systems yield homogeneous shells with quantum yields in the range described herein and dispersibility spanning polar and nonpolar media.

In some examples, the reaction system comprises polar-terminated alkoxy ligands and a dihydroxy-terminated alkoxy solvent. As used herein, “polar-terminated” refers to reaction components in which termini are protic and hydrogen-bonding (for example —OH or —COOH), increasing medium polarity and enabling strong ligand-solvent interactions that stabilize dispersions at high temperature in polyol media. In certain embodiments, the polar-terminated alkoxy ligands include poly(ethylene glycol) monothiol monoacid, poly(ethylene glycol) monothiol monohydroxy, poly(ethylene glycol) diacid, α-hydroxy-ω-propionic acid tetraethylene glycol, and mixtures thereof to balance binding strength and sulfide provision. In related embodiments, the dihydroxy-terminated alkoxy solvent is tetraethylene glycol or higher polyols and may further include mixed backbones such as 2-(2-methoxyethoxy)ethanol when paired to achieve the desired polarity and hydrogen-bonding network.

In some implementations, polar-terminated systems promote in situ condensation chemistry (for example esterification between carboxylic acids and alcohols in the presence of metal cations) that can functionalize the nanocrystal surface with hydroxyls and esters, enable formation of metal oxides (for example CdO or ZnO) under certain conditions, and suppress interparticle crosslinking when balanced ligand mixtures are used. In both methoxy-terminated and polar-terminated classes, ligand and solvent selections are not interchangeable across classes at elevated temperatures; however, after purification, products from either class exhibit broad solvent dispersibility at or near room temperature and maintain photophysical performance suitable for applications described herein.

In some aspects, the reaction system is free or substantially free of alkyl ligands. As used herein, “free” of alkyl ligands means that no alkyl-terminated ligands are intentionally charged to the reaction, corresponding to 0 mol % relative to the total ligand content. “Substantially free” of alkyl ligands means that any alkyl ligand present is at a level that does not materially affect nanocrystal nucleation, growth, dispersion, stability, or purification, and may be limited to less than about 0.1 mol %, less than about 0.5 mol %, less than about 1 mol %, less than about 2 mol %, or less than about 5 mol % of the total ligand content; trace adventitious alkyl impurities from commercial reagents or laboratory ware are contemplated provided they remain below these thresholds and do not measurably alter reaction outcomes.

In some examples, the reaction system is free or substantially free of alkyl solvents. “Free” of alkyl solvents means that no solvent predominantly comprising non-functionalized aliphatic hydrocarbons is intentionally added to the reaction mixture, corresponding to 0 vol % of such solvents. “Substantially free” of alkyl solvents means that the cumulative volume fraction of non-functionalized aliphatic hydrocarbon media is below levels that influence solubility, coordination, or dispersion behavior, and may be limited to less than about 0.1 vol %, less than about 0.5 vol %, less than about 1 vol %, less than about 2 vol %, or less than about 5 vol % of total solvent volume; trace carryover that does not change reaction behavior is contemplated within these limits. In some examples, the reaction system is free or substantially free of both alkyl ligands and alkyl solvents under the foregoing definitions and ranges.

In certain embodiments, the reaction system does not include 1-dodecanethiol or oleic acid. In some embodiments, the reaction system does not include 1-octadecene (ODE) or oleylamine (OLA), oleic acid, trioctylphosphine (TOP), or trioctylphosphine oxide (TOPO). In further embodiments, other examples of excluded components are alkyl ligands such as stearic acid, palmitic acid, myristic acid, lauric acid, behenic acid, linoleic acid, linolenic acid, long-chain primary amines including octylamine, dodecylamine, hexadecylamine, octadecylamine, phosphine and phosphine oxide surfactants such as trioctylphosphine and trioctylphosphine oxide when used as non-alkoxy ligands, octadecylphosphonic acid, long-chain alkyl thiols including hexanethiol, octanethiol, and dodecanethiol variants, and long-chain alkyl carboxylates such as cadmium myristate and cadmium behenate when serving as surface ligands rather than metal sources dissolved and converted in alkoxy media. Examples of reaction solvents and diluents that may be excluded are non-functionalized alkanes and alkenes such as hexane, heptane, octane, decane, dodecane, cyclohexane, mineral oil, squalane, and 1-hexene, long-chain nonpolar solvents including tetradecene and eicosene, and hydrocarbon aromatics employed as primary reaction media such as toluene and xylene; non-alkoxy amines used as bulk reaction solvents, such as neat oleylamine or dodecylamine, are likewise excluded. Any combination of the foregoing may also be excluded.

The foregoing exclusions do not preclude use of alkoxy-functional amines such as tris[2-(2-methoxyethoxy)ethyl]amine or poly(propylene glycol) mono-2-aminopropyl monomethoxyethyl, nor the use of glymes and polyether solvents and ligands that contain alkoxy repeating units and terminal coordinating groups including thiol, carboxyl, hydroxyl, amine, or phosphonic acid. Incidental trace amounts of excluded alkyl materials within the “substantially free” thresholds are contemplated where they do not materially alter nanocrystal formation, growth, dispersibility, stability, or purification performance.

In certain implementations, compliance with “free” or “substantially free” conditions is verified by reagent accounting and, when applicable, by analytical methods indicating the absence or below-threshold presence of excluded alkyl components, recognizing that polyether backbones inherently exhibit aliphatic C—H signatures that are not considered “alkyl ligands” under these definitions.

### Reaction Classes and Component Selection

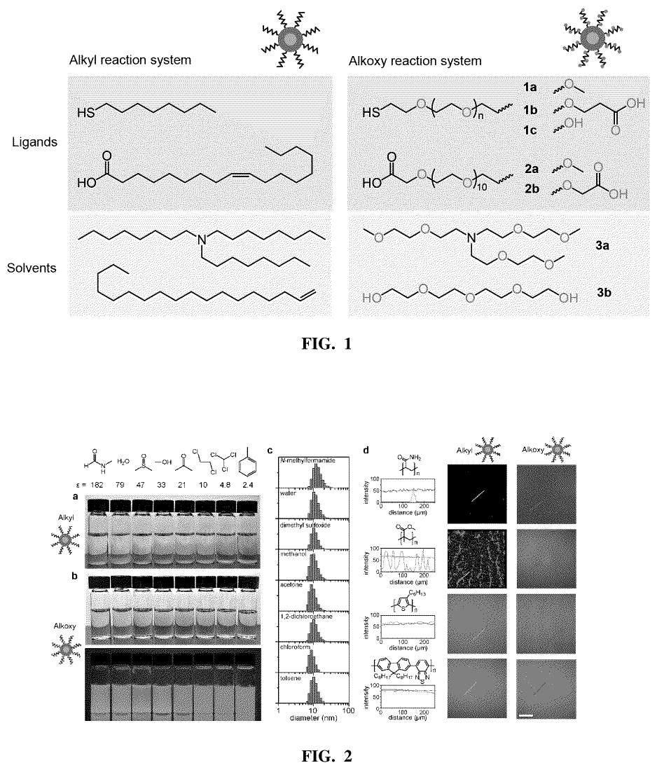

As shown in FIG. 1, the chemical structures of ligands and solvents used in traditional alkyl reaction systems are compared with analogs in alkoxy reactions. The alkoxy reaction components may, in some embodiments, be oligo(ethylene glycol) (OEG) compounds terminated with either methoxy, alcohol, thiol, amine, or carboxylic acid functional groups. The materials may be chosen based on the preference for the final nanocrystal products to be coated with OEG-based ligands, which have a diverse range of aqueous applications and broad dispersibility. The reaction solvents may be further selected based on “like-disperses-like” principles so as to contain similar chemical motifs (ethers) as those functioning as ligands.

### Heteroepitaxial Shell Growth in Alkoxy Media

In some embodiments using the alkoxy reaction, it was found that CdS and CdZnS shells can be grown epitaxially on CdSe nanocrystal cores that were originally synthesized in alkyl reactions. CdSe cores deriving from alkyl reactions homogeneously disperse in the tertiary amine alkoxy solvent of FIG. 1, part 3a at high temperatures when mixed with the two ligands of FIG. 1, parts 1a-1c and FIG. 1, parts 2a-2b in combination, s, respectively, thiol and carboxylic acid coordinating groups. The alkyl-based CdSe core may not disperse stably in solvent 3a without the two ligands and the exclusion of ligand 1a led to precipitation of the CdSe cores at 90° C.

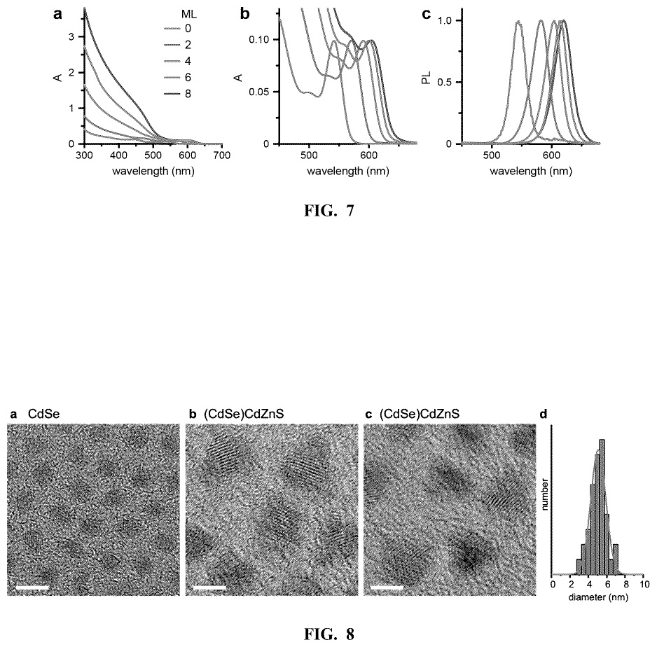

The thiol ligand may decompose at temperatures above 200° C. to release sulfides that in the presence of cadmium acetate and/or zinc acetate yield controlled and continuous growth of CdS or CdZnS shells, as shown in FIG. 7, with high crystallinity by transmission electron microscopy, as shown in FIG. 8, when the thiol:metal molar ratio is between 1.25 to 1.5. Through dropwise addition via a syringe pump, the products may be homogenous (e.g., <12% relative standard deviation diameter) with narrow-bandwidth photoluminescence emission.

### Solvent Dispersibility and Size in Solution

As shown in FIG. 2, there may be clear differences in solvent dispersibility of (CdSe)CdZnS nanocrystals prepared through an alkoxy reaction versus a typical alkyl reaction across solvents spanning a wide range of dielectric constants (F) and functional groups. Nanocrystals from the alkyl reaction dispersed only in low-polarity solvents chloroform (ε=4.8) and toluene (ε=2.4), as shown in FIG. 2, part a, whereas nanocrystals from the alkoxy reaction dispersed in solvents with any dielectric constant, as shown in FIG. 2, part b, including N-methylformamide (ε=182) and water (ε=78.5). Two notable dispersion exceptions were hexane and ether, which are non-solvents for ethylene glycol oligomers and polymers, providing convenient mechanisms of purification. The nanocrystals from alkoxy reactions were photoluminescent in all solvents tested, with a trend of increasing quantum yield with decreasing polarity as shown in Table 1 below.

TABLE 1
Quantum yield (QY) of (CdSe)CdZnS
nanocrystals in different solvents.

| Solvent | Quantum yield QY (%) |
|---|---|
| toluene | 25.0 |
| chloroform | 17.3 |
| 1,2-dichloroethane | 15.4 |
| acetone | 13.4 |
| methanol | 7.2 |
| dimethylsulfoxide | 8.2 |
| water | 9.5 |
| N-methylformamide | 9.2 |

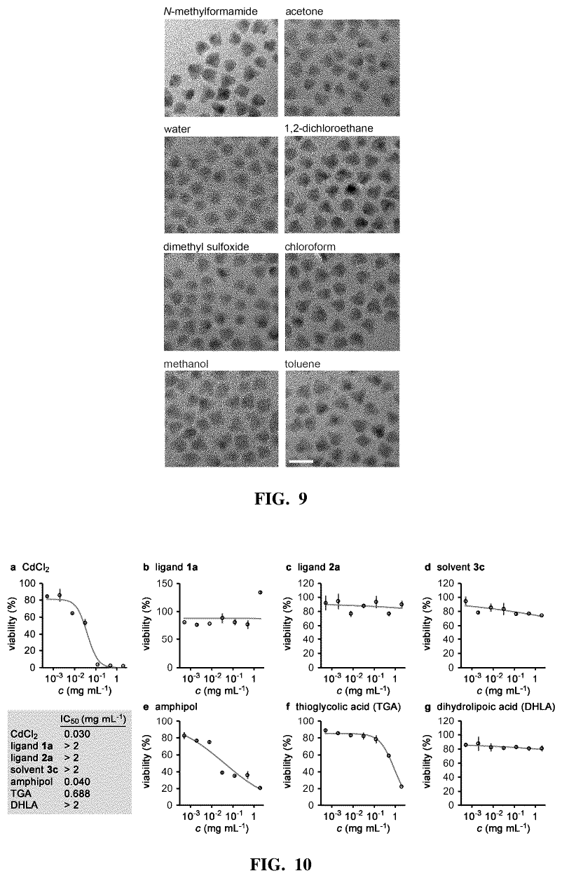

Using the solvent 3a of FIG. 1, quantum yields were near 10% in water but could be increased to more than 20% in water and 30% in toluene using alkoxy solvents with primary amines and thiourea-based sulfide precursors. By dynamic light scattering, the 5-6 nm nanocrystals were 10-11 nm in hydrodynamic diameter in each solvent and were aggregation-free, as shown in FIG. 2, part c, which was consistent with their separation on Transmission Electron Microscopy (TEM) grids after drying from each solvent, as shown in FIG. 9 and described in further detail below. The nanocrystals from alkoxy reactions also dispersed homogeneously and remained photoluminescent in a wide range of polymeric matrices that form device components, as shown in FIG. 2, part d, as well as polyacrylamide hydrogels and hydrophilic polymethyl methacrylate matrices which led to clustering and aggregation of nanocrystals from alkyl reactions.

### Aqueous and Nonpolar Purification Workflows

Nanocrystals from alkoxy reactions may be purified in either aqueous or nonpolar solvents. For aqueous purification, the workflow is shown in FIG. 3, part a: the reaction mixture was diluted in water (25% v/v) and nanocrystals were salted out by dropwise addition of ammonium sulfate (2 M). At the first sign of turbidity, centrifugation yielded a dark pellet containing photoluminescent nanocrystals that readily dispersed in both water and chloroform. For nonpolar solvent purification, the crude solution was diluted in chloroform (25% v/v) and nanocrystals were precipitated by dropwise addition of hexane, again yielding a solid dispersible in both water and chloroform. Tuning the salt or hexane concentration allowed selective sedimentation without phase separation of alkoxy components. The alkoxy-terminated nanocrystals were also purified by aqueous gel permeation chromatography and by filtration; they were retained by 50 kDa molecular weight cut-off (“MWCO”) membranes while the crude solvent mixture eluted, as shown in FIG. 3, part b. The nanocrystals passed through 300 kDa MWCO filters. The aqueous workup processes may lead to less toxic waste products; cytotoxicity comparisons are shown in FIG. 10 and described in further detail below.

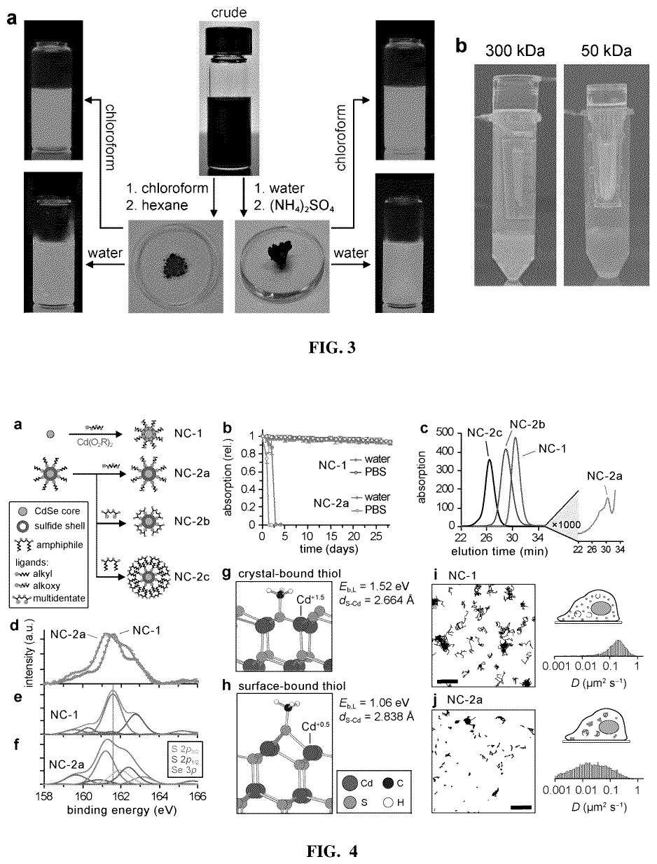

Aqueous-dispersed (CdSe)CdZnS nanocrystals from alkoxy reactions (NC-1) were compared versus structurally equivalent nanocrystals synthesized in alkyl reactions and then dispersed in aqueous solution through hydrophilic surface modification (NC-2), as shown in FIG. 4, part a. NC-2a nanocrystals were ligand-exchanged with ligand 1a, the same ligand and sulfur precursor used in the alkoxy system. NC-2a dispersed in water and phosphate buffered saline but precipitated and quenched within 1-3 days, as shown in FIG. 4, part b. In contrast, NC-1 was stable for more than 4 weeks without loss in fluorescence. The alkoxy reaction products were small (11.5 nm) and homogeneous by gel permeation chromatography in phosphate buffered saline, as shown in FIG. 4, part c, whereas freshly prepared NC-2a aggregated during chromatography (<1% eluted). NC-1 was smaller in hydrodynamic diameter than particles coated with multidentate or amphiphilic polymers that provide long-term aqueous stability. NC-1 showed no detectable aggregates or clustering by gel permeation chromatography.

### Surface Chemistry and Binding States

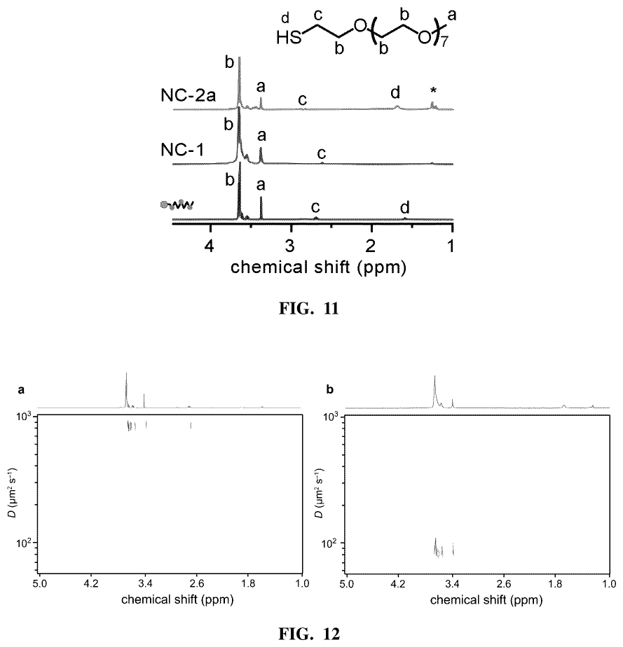

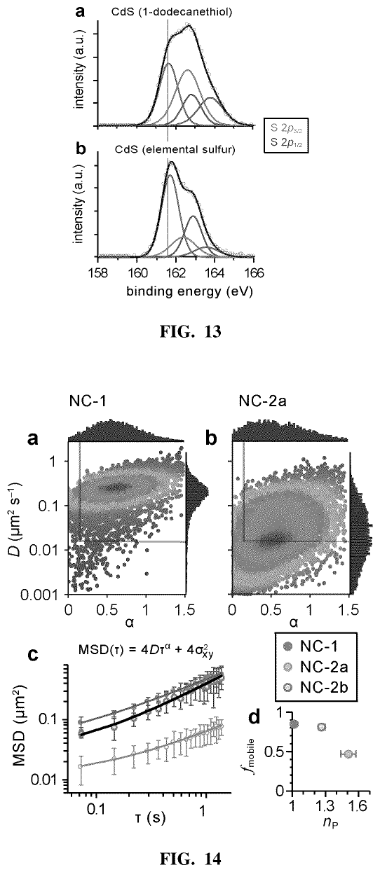

Differences in colloidal stability between NC-1 and NC-2a, despite using the same ligands, may indicate distinct ligand adsorption chemistries. Proton NMR showed equivalent ligand signatures for NC-1 and NC-2a, as shown in FIG. 11, with DOSY confirming expected solvodynamic diameters, as shown in FIG. 12. In contrast, sulfur 2p X-ray photoelectron bands differed between NC-1 and NC-2a, as shown in FIG. 4, parts d-f, indicating different bonding states. The dominant NC-1 sulfur peaks at 161.6 eV and 162.8 eV matched those of pure CdS prepared with an alkanethiol precursor, as shown in FIG. 13 and summarized in Table 2 below. The dominant NC-2a electron binding energy was lower by 0.39 eV, consistent with weaker bonding.

TABLE 2
Experimental XPS binding energies (E_{b, e}) and fitting
parameters for peaks assigned to sulfur 2p orbitals.

| | 2p_{3/2} E_{b, e} | 2p_{1/2} E_{b, e} | | FWHM |
|---|---|---|---|---|
| Sample | (eV) | (eV) | Peak Area ^{a} | (eV) ^{b} |
| NC-1 | 161.61 | 162.79 | 1.0/0.50 | 1.03 |
| | 159.61 | 160.79 | 0.15/0.076 | 1.26 |
| | 160.32 | 161.50 | 0.12/0.060 | 0.83 |
| | 165.21 | 166.39 | 0.10/0.052 | 1.18 |
| NC-2a | 161.22 | 162.40 | 1.0/0.50 | 1.10 |
| | 161.96 | 163.14 | 0.46/0.23 | 1.24 |
| | 159.67 | 160.85 | 0.34/0.17 | 1.30 |
| | 165.73 | 166.91 | 0.094/0.047 | 1.14 |
| CdS | 162.64 | 163.82 | 1.0/0.50 | 1.50 |
| nanocrystal ^{c} | 161.66 | 162.84 | 0.85/0.43 | 1.14 |
| (1- | | | | |
| dodecanethiol) | | | | |
| CdS | 161.71 | 162.89 | 1.0/0.50 | 1.05 |
| nanocrystal ^{c} | 162.39 | 163.57 | 0.34/0.17 | 1.50 |
| (elemental | | | | |
| sulfur) | | | | |

^{a} The first number is the 2p_{3/2} peak area and the second number is the 2p_{1/2} peak area. Values are normalized by setting the area of the largest 2p_{3/2} peak equal to 1.0.
^{b} Peak full width at half maximum.
^{c} Synthesized with indicated sulfur precursor.

### Computational Analysis of Ligand Binding

Density functional theory (DFT) calculations for thiolate ligands on CdS(111) zinc blende slabs, see, Table 3 below, indicate that ligands at the sulfur-terminated face relax to a “crystal-bound” state, as shown in FIG. 4, part g, whereas ligands at the cadmium-terminated face bind in a “surface-bound” mode that disrupts tetrahedral coordination, as shown in FIG. 4, part h. The computed sulfur 2p electron binding energy was higher for the crystal-bound state by 0.63 eV, suggesting NC-1 contains more crystal-bound thiols than NC-2a. The ligand binding energy for the crystal-bound state (E_{b,L}=1.52 eV) exceeded that of the surface-bound state (E_{b,L}=1.06 eV), see Table 4 below.

TABLE 3
DFT calculated sulfur 2p electron binding
energies (E_{b, e}) on CdS(111)_{ZB} slabs.

| | | S | E_{F} | E_{S, 2p} | E_{b, e} |
|---|---|---|---|---|---|
| Structure | S depth^{a} | coordination | (eV) | (eV) | (eV) ^{d} |
| H₃CSH | — | H₃C + H | −1.5949 | −169.23 | 164.00 |
| ligand | 0L ^{b} | H₃C + 3Cd | 0.7787 | −165.80 | 162.94 |
| Crystal- | 0 ^{c} | 3Cd | 0.7677 | −164.13 | 161.26 |
| bound | 1 | 4Cd | 0.8367 | −164.80 | 162.00 |
| | 2 | 4Cd | 0.8182 | −164.64 | 161.82 |
| Surface- | 0L ^{b} | H₃C + 3Cd | 0.2990 | −165.65 | 162.31 |
| bound | 1 | 4Cd | 0.2501 | −165.01 | 161.62 |
| | 1 | 4Cd | 0.3027 | −164.95 | 161.62 |
| | 2 | 4Cd | 0.3039 | −165.15 | 161.81 |
| | 2 | 4Cd | 0.2825 | −165.17 | 161.82 |
| | 3 | 4Cd | 0.3416 | −165.26 | 161.97 |

^{a}Sulfur atoms are labeled by their depth from the slab surface in terms of CdS monolayers with 0 indicating the surface layer. Some coplanar sulfur atoms with distinct bonding geometries after relaxation are listed separately.
^{b} Sulfur 0L corresponds to the methanethiolate ligand bonded to surface cadmium atoms.
^{c} Sulfur 0 corresponds to an unpassivated surface sulfur atom with a single dangling bond.
^{d} Electron binding energies are calculated as the difference between the sulfur 2p orbital energy (E_{S, 2p}) and the Fermi energy (E_{F}), normalized by a core-level shift (~3.64 eV) to match DFT simulations of methanethiol to experimental values of alkanethiols.

TABLE 4
DFT calculated values of methanethiolate ligand binding energies
(E_{b, L}) from energies of isolated CdS(111)_{ZB} slabs (E_{S}), the isolated ligand
(E_{L}), and the ligand bound to slab (E_{S+L}):

| Structure | E_{S+L} (eV) | E_{S} (eV) | E_{L} (eV) | E_{b, L} (eV) |
|---|---|---|---|---|
| Crystal- | −211.16 | −185.18 | −24.46 | −1.52 |
| bound | | | | |
| Surface- | −217.88 | −192.36 | −24.46 | −1.06 |
| bound | | | | |

### Intracellular Imaging and Single-Particle Tracking

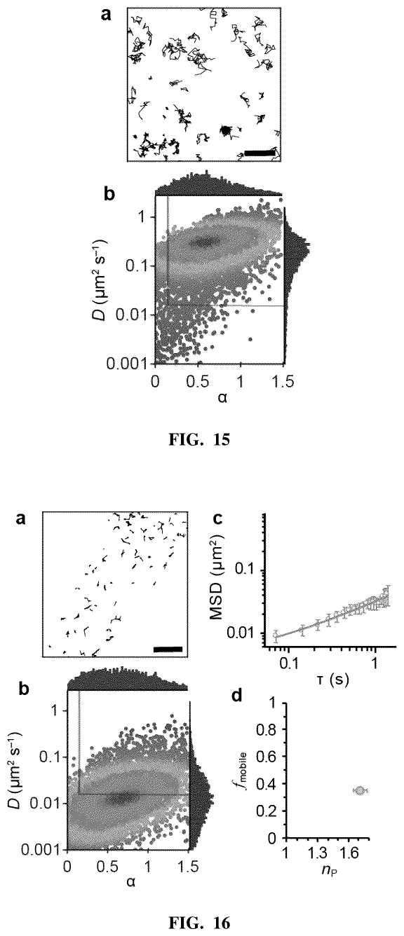

NC-1 performed exceptionally in single-particle imaging and tracking. As shown in FIG. 4, part i, NC-1 exhibited a high intracellular diffusion coefficient D=0.107 μm² s⁻¹ and a high mobile fraction f_{mobile}=85.7% with minimal clustering (n_{P}=1.02), consistent with the distributions in FIG. 14 and Table 5 below. These metrics exceeded those of our prior best-performing polymer-coated particles NC-2b (D=0.090 μm² s⁻¹; f_{mobile}=80.8%; n_{P}=1.27), as shown in FIG. 15. NC-2a with weakly bound ligands showed limited motion (D=0.013 μm² s⁻¹; f_{mobile}=0.47), as shown in FIG. 4, part j, with heterogeneous clustering (n_{P}=1.50), consistent with FIG. 14 and Table 5 below. Similar behavior was observed using a thiolate with a longer hydrophilic tail (2 kDa), as shown in FIG. 16.

TABLE 5
Metrics for single nanocrystal tracking data in living HeLa cells

| | D (μm² s⁻¹) ^{a} | α ^{a} | f_{mobile} ^{b} | n_{P} ^{c} |
|---|---|---|---|---|
| NC-1 | 0.1068 | 0.768 | 0.857 ± 0.043 | 1.019 ± 0.079 |
| | (0.1027, | (0.701, | | |
| | 0.1108) | 0.835) | | |
| NC- | 0.0131 | 0.801 | 0.470 ± 0.093 | 1.504 ± 0.374 |
| 2a | (0.0122, | (0.690, | | |
| (350 | 0.0139) | 0.912) | | |
| Da) | | | | |
| NC- | 0.0074 | 0.630 | 0.350 ± 0.068 | 1.713 ± 0.362 |
| 2a (2 | (0.0064, | (0.470, | | |
| kDa) | 0.0083) | 0.780) | | |
| NC- | 0.0897 | 0.967 | 0.808 ± 0.040 | 1.266 ± 0.169 |
| 2b | (0.0842, | (0.827, | | |
| | 0.0953) | 1.108) | | |
| NC- | 0.0781 | 0.647 | 0.771 ± 0.058 | 1.114 ± 0.094 |
| 3a | (0.0710, | (0.515, | | |
| | 0.0853) | 0.778) | | |

^{a} Fit from ensemble mean squared displacement vs. time increment trends. Values are mean and 95% confidence interval.
^{b} Fraction of mobile nanocrystals, showing mean ± standard deviation across videos, determined from D vs. α plots.
^{c} Mean number of particles per trajectory, showing mean ± standard deviation across videos.

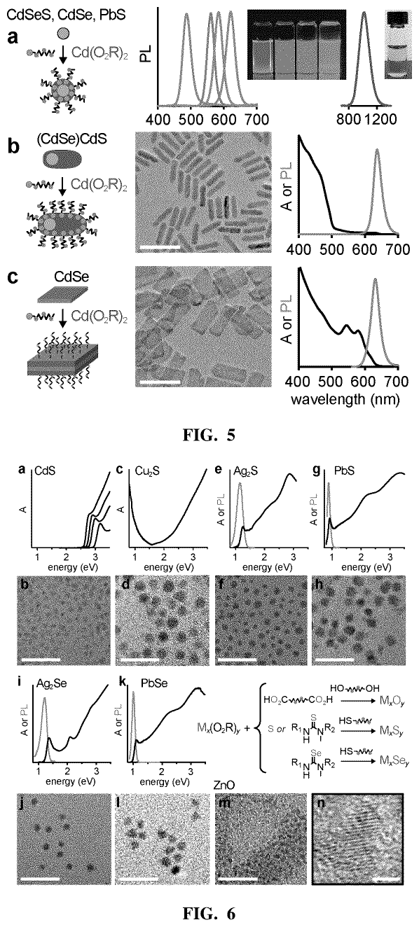

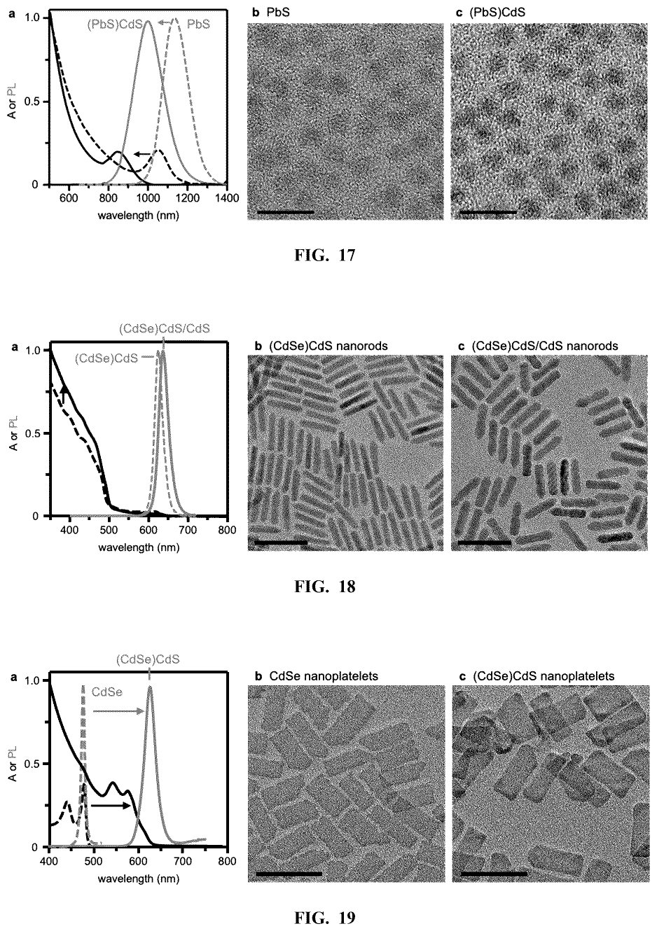

Using similar heteroepitaxial reactions, different sizes of quasi-spherical CdSe and CdSeS nanocrystals from alkyl syntheses were overgrown with CdS or CdZnS using alkoxy reactions. Visible photoluminescence spanning the spectrum and broad solvent dispersibility are shown in FIG. 5, part a. CdS deposition on PbS via low-temperature cation exchange yielded (PbS)CdS with short-wave infrared emission, as shown in FIG. 5, part a and FIG. 17. Anisotropic products, including (CdSe)CdS nanorods and CdSe nanoplatelets, were equivalently overgrown, as shown in FIG. 5, parts b and c, and FIGS. 18-19. Notably, nanorods reached 52% quantum yield in chloroform, exceeding that of dots grown solely by the alkoxy route (25%). Thick shells first deposited at high temperature in alkyl media followed by additional shelling in alkoxy media indicate thicker insulating shells can raise quantum yield further.

### Core Syntheses in Alkoxy Media

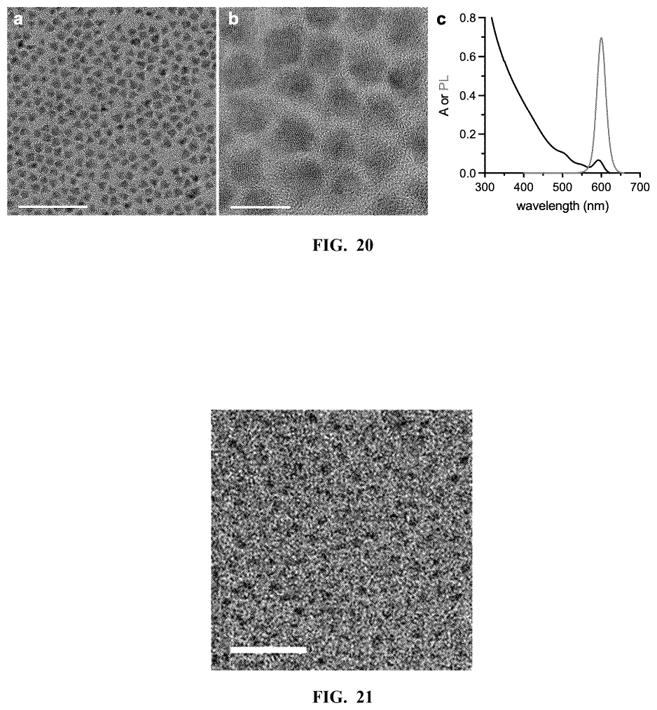

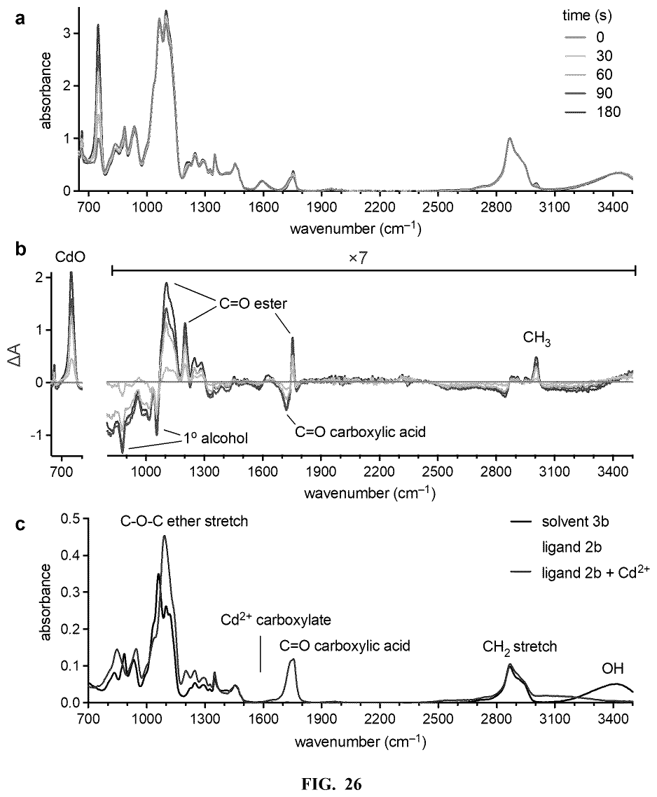

Seed-free nucleation in alkoxy media produced sulfide nanocrystals by injecting elemental sulfur and thiol of FIG. 1 part a into a methoxy-terminated mixture containing metal species chelated by the carboxylate ligand 2 a of FIG. 1 and in the solvent 3a of FIG. 1 at 110-190° C. CdS, Cu₂S, Ag₂S, and PbS products with broad dispersibility are shown in FIG. 6, parts a-d. Elemental sulfur can be replaced by N,N′-di(2-methoxyethyl)-N-methylthiourea, yielding homogeneous products in dimethoxy OEG solvent 3c and, when used as a shell precursor for (CdSe)CdZnS, increasing quantum yield up to 31%, as shown in FIG. 20. Selenide cores (Ag₂Se, PbSe) were synthesized with selenoureas, as shown in FIG. 6, parts e and f. Oxide nanocrystals (CdO, ZnO) formed by injecting dihydroxy solvent 3b into melts of metal-carboxylate complexes of ligand 2b, as shown in FIG. 6, parts g and h, and FIG. 21. Synthesis reproducibility metrics are summarized in Table 6 below and illustrated in FIG. 26.

TABLE 6
Reproducibility metrics from independent
alkoxy synthesis reactions.

| Synthesis reaction | λ_{A} (nm) ^{a} | λ_{PL} (nm) ^{b} | QY ^{c} |
|---|---|---|---|
| CdS(4 ML)/ZnS(2 | 591 | 603 | 17.0% |
| ML) shell growth | 590 | 602 | 16.5% |
| on CdSe (~3.25 | 590 | 602 | 15.8% |
| nm) | | | |
| CdS nanocrystal | 488 | N.A. | N.A. |
| synthesis | 490 | N.A. | N.A. |
| | 487 | N.A. | N.A. |
| PbS nanocrystal | 1345 | 1406 | N.M. ^{d} |
| synthesis | 1294 | 1365 | N.M. ^{d} |
| | 1308 | 1380 | N.M. ^{d} |
| Ag₂S nanocrystal | 985 | 1056 | N.M. ^{d} |
| synthesis | 952 | 1030 | N.M. ^{d} |
| | 912 | 988 | N.M. ^{d} |

^{a} Peak 1S-1S absorption band
^{b} Peak photoluminescence emission band
^{c} Photoluminescence quantum yield in chloroform
^{d} Not measured.

Different combinations of alkoxy-based ligands and solvents identified two non-limiting examples of distinguishable reaction classes that allow nanocrystal growth and colloidal stability at high temperatures. These reactions may be distinguished by terminal functional groups on the reaction components that dictate how nanocrystals interact with the solvent. Terminal groups substantially impact polarity, exemplified by the much higher polarity of dihydroxy-terminated triethylene glycol HO-TEG-OH, ε=23 near room temperature, compared with dimethoxy-terminated triethylene glycol MeO-TEG-OMe, ε=7.2 near room temperature. The first class comprises methoxy-terminated reactions that use less polar components including thiol ligands terminated by methoxy groups, for example 1a, that face outward from the nanocrystal surface. These reactions only generate stable nanocrystals and allow homogeneous growth when the alkoxy solvent is likewise terminated with at least one methoxy group. A second reaction class comprises polar-terminated alkoxy reactions and applies ligands and solvents for which both termini are more polar and protic, such as alcohols, and thus capable of forming hydrogen bonds, for example in 1b, 1c, as shown in Table 7 below, where the descriptions of the ligands and solvents correspond to FIG. 1

TABLE 7
Ligands and solvents used in alkoxy reactions:

| | | Functional | MW | Purity/ | |
|---|---|---|---|---|---|
| Compound | Description | groups | (Da) | Grade | Source |
| 1a | Poly(ethylene glycol) | —SH, | ~350 | ≥95% | Biopharma |
| | monothiol | —OCH₃ | | | PEG |
| | monomethyl ether | | | | MF001003- |
| | | | | | 350 |
| 1b | Poly(ethylene glycol) | —SH, | 370.5 | ≥95% | PurePEG |
| | monothiol monoacid | —COOH | | | 438706 |
| 1c | Poly(ethylene glycol) | —SH, —OH | 254.34 | ≥90% | PurePEG |
| | monothiol | | | | 434505 |
| | monohydroxy | | | | |
| 2a | Poly(ethylene glycol) | —COOH, | ~550 | ≥95% | Biopharma |
| | monoacid | —OCH₃ | | | PEG |
| | monomethyl ether | | | | MF001017- |
| | | | | | 550 |
| 2b | Poly(ethylene glycol) | —COOH, | ~600 | for | Sigma- |
| | diacid | —COOH | | synthesis | Aldrich |
| | | | | | 8439120250 |
| 2c | α-Hydroxy-ω- | —COOH, | 266.29 | ≥97% | PurePEG |
| | propionic acid | —OH | | | 434204 |
| | tetraethylene glycol | | | | |
| 3a | Tris[2-(2- | tertiary | 323.43 | 95% | Sigma- |
| | methoxyethoxy)ethyl] | amine, | | | Aldrich |
| | amine | —OCH₃ | | | 301248; |
| | | | | | TCI |
| | | | | | T1231; |
| | | | | | Alfa |
| | | | | | Aesar |
| | | | | | L13544 |
| 3b | Tetraethylene glycol | —OH, —OH | 194.23 | 99% | Sigma- |
| | (TEG) | | | | Aldrich |
| | | | | | 110175 |
| 3c | Poly(ethylene glycol) | —OCH₃, | 530.65 | for | Sigma- |
| | dimethyl ether | —OCH₃ | | synthesis | Aldrich |
| | | | | | 8.14171 |
| 3d | Poly(ethylene glycol) | —OH, | ~500 | BioUltra | Sigma- |
| | monohydroxy | —OCH₃ | | | Aldrich |
| | monomethyl ether | | | | 71578 |
| 3e | Poly(propylene | —NH2, | ~600 | N.A. | Sigma- |
| | glycol) mono-2- | —OCH₃ | | | Aldrich |
| | aminopropyl | | | | 422118 |
| | monomethoxyethyl | | | | |

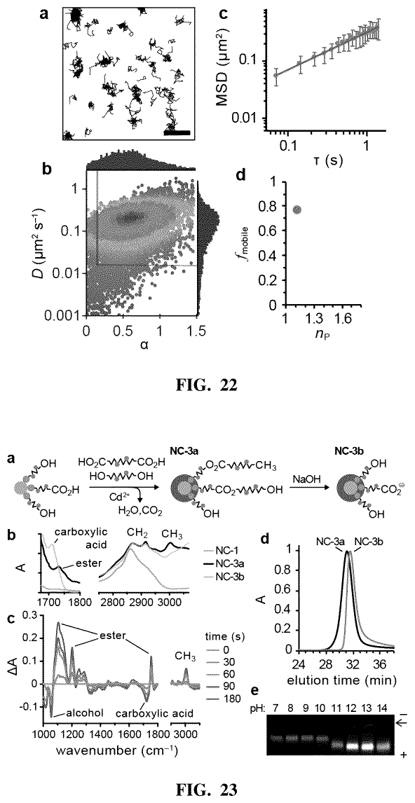

In the above non-limiting example, ligands and solvents were not interchangeable across the two reaction classes. Despite these differences, after purification, nanocrystals from both reaction classes dispersed in a wide range of solvents near room temperature, and the polar-terminated nanocrystals performed similarly to NC 1 in intracellular diffusion assays as shown in FIG. 22. This disparity in dispersion between low and high temperatures likely arises from the temperature dependence of interactions between ligand and solvent. With increasing temperature, weaker dipole-dipole interactions between ethers dissociate while stronger hydrogen bonds remain, exemplified by the higher boiling point of tetraethylene glycol (HO TEG OH), 285° C., compared with triethylene glycol dimethyl ether (MeO TEG OMe), 216° C. Therefore, at elevated temperatures, polar terminated nanocrystals may self-associate to colloidally destabilize in methoxy terminated solvents.

Likewise, a suspension of methoxy-terminated nanocrystals destabilizes in polar solvents due to solvent self-association. The solvent dependence of nanocrystal dispersion is not completely understood, even near room temperature, and chemical reactions at high temperatures may play important roles as well. Nanocrystal growth requires ligand displacement from the surface and, in the case of thiol-based shell precursors, requires ligand cleavage, both of which may destabilize the dispersion. Polar-terminated reaction classes also undergo side reactions, including esterifications between ligands and solvents which lead to nanocrystals from these reactions functionalized with both esters and alcohols as shown in FIGS. 23-26. These condensation reactions can produce oxide nanocrystals including CdO as shown in FIG. 21.

### Methoxy-Terminated Reaction Class

In certain examples, for CdS shell growth using methoxy-terminated ligands 1a and 2a, maintaining colloidal stability at elevated temperature and enabling shell growth required methoxy-terminated solvents, such as, 3a or dimethoxy-terminated oligo(ethylene glycol) 3c. In contrast, the dihydroxy-terminated solvent 3b induced precipitation at high temperature. The tertiary amine in 3a functions as an electron-donating L-type ligand and/or Lewis base; fully substituting 3a with 3c led to poor sulfide shell growth. In these reactions, solvent 3a could be replaced with other electron-donating solvents, including monohydroxy- or monomethoxy-oligo(ethylene glycol) 3d or monoamine-oligo(propylene glycol) 3e. The primary amine coordinating solvent 3e produced higher quantum yields from sulfide shell growth greater than 30% and showed that an ethylene glycol backbone is not required for compatibility with alkoxy reactions.

In certain examples, for shell growth and core nucleation, thiol ligands such as 1a were necessary to stabilize products across diverse solvents, except when thiourea derivatives served as sulfur precursors; in those cases, an excess of primary amine solvent 3e and carboxylic acid ligand 2a sufficed, though thiols were still required to initially disperse alkyl-derived cores for heteroepitaxy.

### Polar-Terminated Reaction Class

In some embodiments, for CdS shell growth with thiol ligands bearing terminal hydroxyl and carboxyl groups 1b and 1c, high-temperature shell growth and colloidal stability required the dihydroxy solvent 3b; methoxy-terminated solvents such as 3a caused precipitation. Despite the propensity for polar bifunctional systems to crosslink, only specific ligand-solvent combinations yielded stable products. Individually, ligand 1b or 1c produced poor growth, whereas their combination with dicarboxylic ligand 2b afforded nanocrystals of similar quality to those from methoxy-terminated systems. In the proposed mechanism, the polar-terminated mixture of 1b, 1c, 2b, and 3b provides thiol-terminated 1b and 1c that bind as ligands and also serve as sulfide sources to generate NC-3a.

Polar-terminated alkoxy reactions may yield esterified, hydroxyl-terminated ligands on nanocrystals. Spectroscopic and physicochemical data indicate NC-3a ligands are hydroxyl-terminated even when carboxyl ligand 1c is in excess relative to 1b. NC-3a exhibited a zeta potential of −18.1±0.8 mV in aqueous solution at pH 8.5, substantially larger in magnitude than methoxy-terminated NC-1 at −1.5±0.3 mV, consistent with the need for more polar solvent in the polar-terminated system. The NC-3a zeta potential matched that of nanocrystals obtained by alkyl synthesis followed by exchange with hydroxy-terminated 1c at −17.5±0.6 mV and was smaller in magnitude than those exchanged with carboxy-terminated 1b at −37.5±1.2 mV. These findings are consistent with esterification of carboxylic acids by excess alcohols from solvent 3b. By infrared spectroscopy, hydroxyls and esters were both present in NC-3a but not NC-1, and esters formed within seconds in mixtures of 2b, 3b, and Cd²⁺ at 220° C.

Ester cleavage under basic conditions at pH greater than 11 for six hours produced NC-3b with reduced hydrodynamic size by gel permeation chromatography from 10.7 nm to 9.9 nm and increased electrophoretic mobility. The prevalence of esterifications likely underlies the requirement for excess dicarboxy ligand 2b and may suppress interparticle crosslinking that otherwise leads to aggregation when using polar bifunctional ligands and solvents. A balanced mixture of ligand 1b and 1c may thus be needed for stable dispersion in the mixed-polarity medium of 2b and 3b. Methyl groups observed in the NC-3a spectrum and in the solvent reaction are consistent with thermolytic decarboxylation of cadmium precursors through carbanion intermediates, a decomposition pathway reported for cadmium chalcogenide nanocrystal syntheses.

### Optical and Electron Microscopy Characterization

As shown in FIG. 7, a non-limiting photophysical characterization of epitaxial CdS shell growth on CdSe cores using methoxy-terminated alkoxy reagents is presented. Panel a shows absorbance spectra for nanocrystals with the indicated number of CdS shell monolayers (ML), with increased absorbance at wavelengths shorter than 500 nm consistent with CdS deposition. Panel b provides a zoomed-in band-edge region showing retention of distinct absorbance features throughout shell growth. Panel c shows photoluminescence spectra with narrow bandwidths indicative of homogeneity; the quantum yield remains near 1% until the 3rd ML and then rises steadily to approximately 20% in chloroform by the 6th ML.

FIG. 8 characterizes example products of CdZnS shell growth on CdSe cores using methoxy-terminated alkoxy reagents. High-resolution transmission electron micrographs show (a) quasi-spherical CdSe from an alkyl reaction used as a core to generate (b,c) (core)shell (CdSe)CdZnS nanocrystals from alkoxy shell growth. Faceting and selective growth are observed in the [110] zinc blende direction, yielding quasi-tetrahedral shapes. Panel d shows a size histogram corresponding to panels (b,c) with a diameter of 5.1±0.6 nm (mean±standard deviation). The scale bars are 5 nm.

Turning to FIG. 9, non-limiting examples of transmission electron micrographs of (CdSe)CdZnS nanocrystals from methoxy-terminated alkoxy shell growth are shown after casting from the indicated solvents. All panels share the same 10 nm scale bar.

### Cytotoxicity of Reagents and Coatings

In FIG. 10, example cytotoxicity measurements of alkoxy reaction components and common phase transfer agents are reported using MTT viability assays in HeLa cells. Alkoxy components include ligands 1a and 2a and solvent 3c; traditional phase transfer agents include octylamine-modified polyacrylic acid (amphipol), thioglycolic acid (TGA), and dihydrolipoic acid (DHLA). CdCl₂ is included as a positive control. Cells are exposed for 24 hours to the indicated concentrations. Percent viability is calculated relative to medium-only controls and shown as mean±standard error from triplicate biological replicates. IC50 values are obtained by dose-response fitting.

As shown in FIG. 11, example ¹H NMR spectra of ligand 1a, NC-1, and NC-2a are presented, with an asterisk indicating residual impurities. Supplementary diffusion data are provided in FIG. 12.

FIG. 12 reports diffusion-ordered NMR spectroscopy (DOSY) in deuterated chloroform for (a) ligand 1a and (b)NC-1. Diffusion coefficients of the highest-amplitude peaks are 830.41±0.60 μm² s⁻¹ (3.67 ppm) for ligand 1a and 84.34±1.56 μm² s⁻¹ (3.67 ppm) for NC-1. The corresponding solvodynamic diameter for NC-1 is 9.55±0.18 nm, matching the hydrodynamic diameter from dynamic light scattering. The ligand 1a solvodynamic diameter is 0.48 nm.

### Surface Chemistry and Binding Analysis

FIG. 13 presents example sulfur 2p X-ray photoelectron spectra, fits, and spectral decomposition of CdS nanocrystals synthesized using alkyl reactions with different sulfur precursors: (a) 1-dodecanethiol or (b) elemental sulfur. A vertical line guides comparison to the primary peak from the NC-1 spectrum.

As detailed in FIG. 14, example metrics for dynamic single-particle fluorescence microscopy and tracking of nanocrystals in living HeLa cells after intracellular delivery by osmotic pinosome lysis are shown. Diffusion coefficients (D) and anomalous diffusion parameters (α) are calculated for (a) 7,110 tracks for NC-1 and (b) 6,690 tracks for NC-2a, with black lines indicating cutoffs for mobile versus immobile tracks. Panel c shows mean squared displacement versus time increment for NC-1, NC-2a, and NC-2b, aggregated across all tracks (7,110 for NC-1; 6,690 for NC-2a; 6,208 for NC-2b) with data as mean±standard deviation. Part d shows the fraction of tracks that are mobile versus the number of particles per track based on intensity distributions, aggregated across all tracks and shown as mean±standard error to the mean.

FIG. 15 shows examples of dynamic single-particle fluorescence microscopy and tracking of NC-2b in living HeLa cells after intracellular delivery by osmotic pinosome lysis. Panel a provides example trajectories (scale bar: 5 μm). Panel b shows diffusion coefficients (D) and anomalous diffusion parameters (α) for 6,208 tracks.

In FIG. 16, non-limiting dynamic single-particle fluorescence microscopy and tracking are shown for nanocrystals prepared identically to NC-2a except using a thiol ligand with a longer hydrophilic domain (2 kDa poly(ethylene glycol) monothiol monomethyl ether). Panel a shows example trajectories (scale bar: 5 μm). Panel b provides diffusion coefficients (D) and anomalous diffusion parameters (α) for 6,399 tracks. Panel c shows mean squared displacement versus time increment aggregated across all 6,399 tracks with D=0.0074 μm² s⁻¹ (mean±standard deviation). Panel d shows the fraction of tracks that are mobile (mean f_{mobile}=0.35) versus number of particles per track (mean nₚ=1.71), reported as mean±standard error to the mean.

### Cation Exchange and Anisotropic Structures

As shown in FIG. 17, example characterization of PbS and (PbS)CdS generated by cadmium cation exchange in methoxy-terminated alkoxy systems is provided. Panel a shows absorbance (black) and photoluminescence (grey) spectra of PbS cores before (dashed) and after cation exchange (solid), both exhibiting blue-shifts consistent with exchange and narrow features indicating homogeneity. High-resolution TEM shows (b) PbS and (c) (PbS)CdS nanocrystals with similar sizes, consistent with a cation exchange process. The scale bars are 10 nm.

FIG. 18 characterizes example (CdSe)CdS nanorods before and after shell growth in methoxy-terminated alkoxy reactions. Panel a overlays absorbance (black) and photoluminescence (grey) spectra before (dashed) and after (solid) shell growth, with increased sub-500 nm absorbance and a red-shift in emission consistent with shell growth; narrow photoluminescence bandwidths indicate homogeneity. Before shell growth, the photoluminescence quantum yield is 77% in chloroform; after shell growth, it is 52% in chloroform and 24% in water. Panels b and c show high-resolution TEM of nanorods before and after shell growth, with similar lengths and increased thickness post-deposition. The field of view in panel c is similar to FIG. 5, panel b. The scale bars are 50 nm.

As detailed in FIG. 19, CdSe nanoplatelets and (CdSe)CdS nanoplatelets generated by CdS shell growth in methoxy-terminated alkoxy reactions are characterized. Panel a shows absorbance (black) and photoluminescence (grey) before (dashed) and after (solid) shell growth, both red-shifting consistent with CdS deposition and displaying narrow photoluminescence and distinct absorbance features indicating homogeneity. Before shell growth, the photoluminescence quantum yield is 2.6% in chloroform; after growth, the quantum yield is 7.9% in chloroform and 4.7% in water. Panels b and c show TEM of CdSe and (CdSe)CdS nanoplatelets with similar dimensions, typical of thickness-dominant growth. The field of view in panel c is similar to part c of FIG. 5. The scale bars are 50 nm.

### Methoxy-Terminated Route with Thiourea Precursors

FIG. 20 presents example (CdSe)CdZnS nanocrystals generated by CdZnS shell growth in methoxy-terminated alkoxy reactions using N,N′-di(2-methoxyethyl)-N-methylthiourea as the sulfur precursor. Parts a and b show representative high-resolution TEM images (scale bars: 50 nm and 10 nm). Panel c shows absorbance (black) and photoluminescence (red) after shell growth; the photoluminescence quantum yield is 31% in toluene.

### Polar-Terminated Chemistry, Esterification, and Hydrolysis

As shown in FIG. 21, a representative transmission electron micrograph of cadmium oxide nanocrystals deriving from the polar-terminated alkoxy reaction is provided. The scale bar is 20 nm.

FIG. 22 reports dynamic single-particle fluorescence microscopy and tracking of (CdSe)CdZnS nanocrystals synthesized using polar-terminated alkoxy reactions (NC-3a) after intracellular delivery by osmotic pinosome lysis. Panel a shows example trajectories (scale bar: 5 μm). Panel b provides individual diffusion coefficients (D) and anomalous diffusion parameters (α) for 7,962 tracks. Panel c shows mean squared displacement versus time increment aggregated across all tracks with D=0.078 μm² s⁻¹ (mean±standard deviation). Panel d shows the fraction of tracks that are mobile (mean f_{mobile}=0.77) versus number of particles per track (mean n_{P}=1.11), shown as mean±standard error to the mean

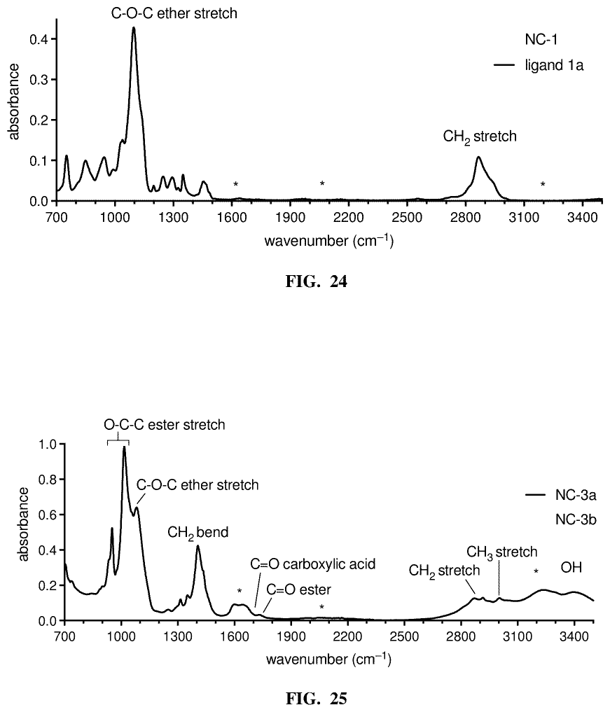

As depicted in FIG. 23, example chemical functionalization of (CdSe)CdZnS nanocrystals from alkoxy-based shell growth reactions using reagents 1b, 1c, 2b, and 3b with polar termini (hydroxyls and carboxylic acids) is summarized. Panel a provides a schematic of the shell growth reaction to generate NC-3a and subsequent aqueous base treatment to generate NC-3b. Panel b shows Fourier Transform Infrared (FT-IR) spectra of NC-1, NC-3a, and NC-3b highlighting bands specific to carboxylic acids and esters, as well as methylene and non-methoxy methyl groups; complete spectra are shown in FIGS. 24 and 25. Panel c shows FT-IR difference spectra for a reaction mixture of 2b, 3b, and Cd²⁺ at 220° C. over time; complete spectra are shown in FIG. 26. Panel d provides GPC chromatograms of freshly purified NC-3a and NC-3b with reduced size due to base hydrolysis (6 hours at pH 11). Panel e shows agarose gel electrophoresis of NC-3a after 6 hour treatments at the indicated pH (mobile phase: sodium borate buffer, pH 8.5).

FIG. 24 provides example FT-IR spectra of NC-1 and ligand 1a, showing similar ether functional groups and an absence of esters (˜1750 cm⁻¹), hydroxyls (˜3400 cm⁻¹), and methyl groups (˜3000 cm⁻¹). Some adsorbed water (*) remains in NC-1 after aqueous purification and drying.

Turning to FIG. 25, example FT-IR spectra of NC-3a and NC-3b are shown. Hydroxyls, esters, and methyl groups are present in NC-3a; after base treatment, NC-3b exhibits conversion of esters to carboxylic acids and disappearance of methyl groups. Water (*) remains adsorbed in both samples after aqueous purification and drying.

FIG. 26 presents example FT-IR spectra of a reaction system of solvent 3b and ligand 2b chelating Cd²⁺ (CdO reacted with 2b under vacuum). Panel a shows spectra over time at 220° C. Panel b provides difference spectra with respect to time zero, showing an increase in carboxylic acid esters and a depletion of carboxylic acids and hydroxyls, with bands corresponding to non-methoxy methyl groups and CdO increasing. Panel c shows spectra of 3b, 2b, and the 2b-chelated Cd²⁺ complex.

### Ternary Shell Growth and Quantum Dot (QD) Performance

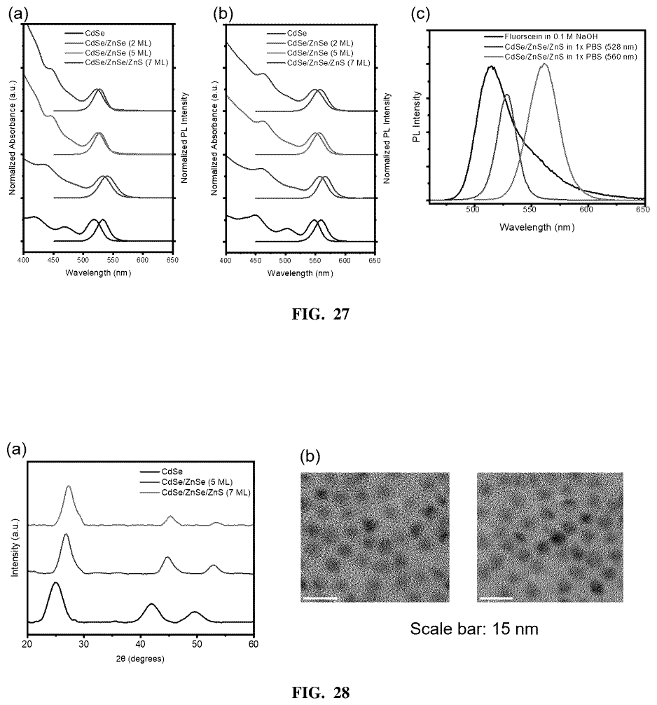

As shown in FIG. 27, example absorption and photoluminescence spectra acquired during stepwise shell growth are presented for CdSe/ZnSe/ZnS quantum dots tuned to 528 nm (QD528, panel a) and 560 nm (QD560, panel b). Deposition of an initial 2 ML ZnSe shell produces a red shift in the first and third excitonic peaks in both absorbance and emission. Addition of a further 3 ML ZnSe shell yields a blue shift of the first excitonic peak and a red shift of the third excitonic peak in absorbance, accompanied by a blue shift in the emission maximum. Final growth of a 2 ML ZnS shell in the alkoxy system does not appreciably alter the overall shapes of the absorbance or emission spectra. Panel c summarizes relative quantum yields measured using fluorescein as the reference dye: QD528 exhibits a quantum yield of 32.5% in PBS, while QD560 exhibits 56.8% under identical conditions.

### Short-Wave Infrared Nanocrystals and Ligand-Length Tuning

Turning to FIG. 28, example X-ray diffraction patterns recorded during the synthesis of QD528 are shown in panel a, and indicate retention of the zinc blende crystal structure throughout growth. Deposition of a 5 ML ZnSe shell induces shifts of the (111), (220), and (311) reflections; subsequent addition of a 2 ML ZnS shell in the alkoxy system causes further shifts relative to CdSe/ZnSe, confirming contraction of the crystalline lattice with deposition of shells with shorter bond lengths than the CdSe core. Panel b provides transmission electron micrographs of QD528 collected on a JEOL 2100, demonstrating uniform and homogeneous particle size; image resolution and contrast remain subject to optimization.

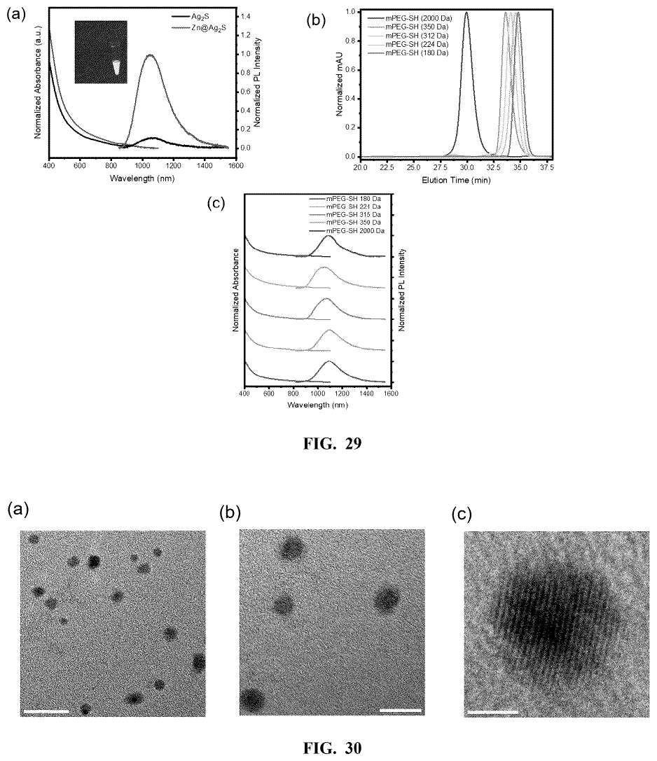

FIG. 29 presents short-wave infrared materials based on Ag₂S. Panel a compares absorbance and photoluminescence spectra of Ag₂S and Zn-doped Ag₂S in water, where Zn doping markedly increases photoluminescence intensity; the difference in brightness is also evident under an InGaAs camera. Panel b shows fast protein liquid chromatography (FPLC) of Zn-doped Ag₂S prepared with Methoxy-Polyethylene Glycol-Thiol (mPEG-SH) ligands of different molecular weight, where decreasing mPEG-SH length reduces hydrodynamic size from 12.6 nm to 5.4 nm. Panel c overlays absorbance and emission spectra for Zn-doped Ag₂S as a function of mPEG-SH molecular weight, showing a red shift of the emission peak from 1045 nm to 1099 nm with decreasing ligand length. Particles bearing 2000 Da polyethylene glycol (PEG) are obtained by ligand exchange from Zn-doped Ag₂S initially coated with 224 Da mPEG-SH.

As depicted in FIG. 30, transmission electron microscopy of Zn-doped Ag₂S synthesized with 180 Da mPEG-SH is shown at multiple magnifications. Panels a-c provide images acquired with scale bars of 20 nm, 10 nm, and 2 nm, respectively. The micrographs demonstrate crystalline nanoparticles; size distribution and on-grid particle density can be further optimized.

### Alkyl Core Synthesis

In some embodiments, CdSe cores were prepared in alkyl media by charging a 25 mL round-bottom flask with cadmium behenate 0.2 mmol, selenium dioxide 0.2 mmol, 1,2-hexadecanediol 0.4 mmol, and octadecene 5 mL, degassing at ˜120° C. for 15 minutes, and heating to 245-250° C. at ˜20° C. min-1 for 60 minutes under nitrogen. The mixture was cooled to ˜200° C., oleic acid 0.5 mL was added, and the solution was cooled to room temperature. Cores used in FIGS. 2-5 were ˜3.2 nm in diameter with first excitonic absorbance at ˜550 nm and emission at ˜560 nm. Purification used hexanes dilution 5-fold, centrifugation at 5000 g, two cold (4° C., 24 hours) settle/centrifuge cycles, and sequential methanol 2 mL and acetone 8 mL addition, vortexing, and centrifugation at 5000 g for 5 minutes. The precipitate was dispersed in hexane 4 mL, extracted with methanol 4 mL, the top phase volume increased to ˜4 mL with hexane, re-extracted with fresh methanol 4 mL, then diluted with methanol 2 mL and acetone 8 mL, vortexed, centrifuged at 5000 g for 5 minutes, and the pellet was dispersed in chloroform ˜2 mL. Alkyl syntheses of CdS, CdSeS, PbS, CdSe nanoplatelets, and (CdSe)CdS nanorods followed the procedures summarized below.

### Layer-by-Layer Alkyl Shell Growth on CdSe (CdS/ZnS)

In certain aspects, Alkyl shell growth on CdSe cores used layer-by-layer deposition of CdS and ZnS. In these aspects, purified cores 75 nmol in hexane, octadecene 2 mL, and oleylamine 1 mL were combined in a 50 mL flask, hexane was evaporated at 45° C., and the mixture was heated to 120° C. under nitrogen. Shells were grown as 0.8 monolayer increments with alternating sulfur and cadmium or zinc additions from 0.1 M precursor solutions (cadmium acetate in oleylamine, zinc acetate in oleylamine, sulfur in octadecene) delivered dropwise over 3-5 minutes with 15 minutes stirring between additions, increasing temperature by ˜10° C. per layer to a maximum of 180° C. Aliquots were taken after each cation addition for optical characterization. For (CdSe)CdZnS made by alkyl methods, 3.6 ML CdS followed by 1 ML ZnS yielded ˜5.2 nm particles with absorbance at ˜590 nm and photoluminescence at ˜600 nm. Polymer composite incorporation and phase transfer to generate NC-2a, NC-2b, and NC-2c followed aqueous workflows described below.

### Alkoxy Shell Growth (Thiol Route) on Diverse Cores

For some embodiments directed to alkoxy-shell growth solutions, anhydrous cadmium acetate was dissolved in tris[2-(2-methoxyethoxy)ethyl]amine (3a) by ultrasonication to 0.1 M, and ligand 1a was dissolved in 3a to 0.125 M sulfur-equivalent under nitrogen.

Alkoxy shell growth on nanocrystals using thiol precursors was performed, in certain examples, by mixing purified CdSe cores 75 nmol in chloroform with ligand 1a 0.2 mmol and ligand 2a 0.25 mmol in chloroform 0.2 mL, adding 3a 3 mL, degassing at ˜100° C. for 15 minutes, and flushing with nitrogen. Cadmium and sulfur precursor solutions were added dropwise from separate syringes at 3 mL hr⁻¹ while heating at ˜15° C. min⁻¹ to 210° C. After addition sufficient for 0.8 ML CdS, the addition was paused for 15 minutes of stirring, then resumed at 220° C. to reach the desired CdS thickness. For ZnS, the dispersion was cooled to room temperature, zinc acetate was added for 1 ML, the solution was degassed at 100° C. for 5 minutes, heated to 220° C., and sulfur precursor was injected at equivalent molar amount, followed by a 15 minute anneal at 220° C. and cooling. This sequence was repeated to add additional ZnS layers; 4 ML CdS followed by 2 ML ZnS were applied. The same method was adapted for CdSeS cores, PbS cores (at 120° C., yielding CdS by cation exchange, with continuous sulfur addition and no ZnS), (CdSe)CdS nanorods (220° C., no ZnS), and CdSe nanoplatelets (220° C., no ZnS).

### Methoxy-Terminated Alkoxy Core Syntheses

Alkoxy core syntheses used cadmium acetate 0.1 mmol, ligand 2a 0.25 mmol, and 3a 3 mL degassed at 100° C. for 30 minutes under nitrogen. A 0.1 M sulfur solution in 3a was prepared and supplemented with ligand 1a 1 M. The cadmium solution was heated to 205° C. and sulfur solution 0.2 mL was injected; growth proceeded at 180° C. for 60 minutes with size-selected aliquots. Ag₂S, Cu₂S, PbS, Ag₂Se, ZnO, and CdO syntheses followed analogous alkoxy workflows described below.

### Aqueous and Nonpolar Purification; Membrane Filtration

Alkoxy purification by aqueous precipitation was done by diluting crude reaction mixture 0.5 mL with water 1.5 mL, then adding ammonium sulfate 2 M dropwise with stirring until turbidity, centrifuging at 5000 g for 5 minutes, and redispersing the pellet in diverse solvents. Nonpolar precipitation diluted crude 0.5 mL with chloroform 1.5 mL, added hexane ˜8 mL slowly with vortexing for 30 seconds, centrifuged at 5000 g for 5 minutes, and redispersed the pellet. Aqueous filtration transferred nanocrystals in water 0.5 mL to a 100 kDa centrifugal filter, centrifuged at 3000 g for 5 minutes, discarded filtrate, replenished retentate volume to 0.5 mL with water, and repeated 7-8 times while monitoring filtrate.

### Analytical Characterization Workflow

Characterization included NMR (nuclear magnetic resonance), Fourier Transform Infrared (FT-IR) spectroscopy, optical absorption, photoluminescence, XPS (X-ray photoelectron spectroscopy), TEM (transmission electron microscopy), dynamic light scattering, zeta potentiometry (zeta potential measurement), gel permeation chromatography (GPC), and colloidal stability, with acquisition parameters as in the detailed protocols. Data visualization used standard software.

### Intracellular Single-Particle Tracking Protocol

In certain aspects, for intracellular single-particle tracking, HeLa cells were seeded at 20,000 cells cm⁻² in 8-well chambers and cultured 24 hours in phenol red-free Dulbecco's Modified Eagle's Medium (DMEM) with 10% Fetal Bovine Serum (FBS). Cells were incubated with hypertonic Influx reagent containing 10 nM nanocrystals at 37° C. for 10 minutes, exchanged to hypotonic lysis medium (phenol red-free DMEM:water 6:4 v/v) for 3 minutes at 37° C., then to complete phenol red-free DMEM with 10% FBS for 10 minutes. Nuclei were stained with Hoechst 10 minutes, bromocresol green 200 μM was added to quench extracellular fluorescence, and cells were imaged immediately with HiLo on a Zeiss Axio Observer.Z1, 100×NA 1.45 objective, EMCCD camera at 13.7 frames per second to acquire 2000-frame videos. Trajectories were extracted with u-track and analyzed in MATLAB to compute mean square displacement MSD versus time increment τ using the anomalous diffusion model MSD(τ)=4D τ^{α}+4σ_{xy}² where D is the diffusion coefficient, α the confinement parameter, and σxy the mean localization error. Mobile tracks were defined by D>0.020 μm² s⁻¹ and α>0.21. Mean intensity per particle yielded the mean number of particles nₚ per track.

### Density Functional Theory (DFT) Modeling

DFT simulations used zinc blende CdS slabs with {111}facets and H3CS− ligands to compute ligand binding energy and sulfur 2p electron binding energies. Surface-bound ligands were modeled on cadmium-terminated (111) with the opposing 1̅1̅1̅ facet passivated by pseudo-hydrogens; crystal-bound ligands were modeled on sulfur-terminated 1̅1̅1̅ with methyl passivation on the opposing (111). The ligand binding energy was defined as E_{b,L}=E_{S+L}−(E_{S}+E_{L}) and the electron binding energy per sulfur as

E_{b,e}=E_{F}−E_{S,2p}−E_{CLS} with core-level shift determined by E_{CLS}=E_{b,L,sim}−E_{b,L,exp} to normalize 2p3/2 values to an alkanethiol standard.

### Materials Used

Materials included behenic acid (BAc), bis(trimethylsilyl) sulfide ((TMS)₂S), bromocresol green, cadmium acetate (Cd(Ac)₂), cadmium oxide (CdO), copper(II) acetate (Cu(Ac)₂), 1-dodecanethiol, 1,2-hexadecanediol (HDD), lead(II) acetate trihydrate, lead(II) chloride (PbCl₂), lead(II) oxide (PbO), (2-methoxyethyl)methylamine, 1-octadecene (ODE), octadecylphosphonic acid (ODPA), oleylamine, poly(3-hexylthiophene-2,5-diyl) (P3HT), poly[(9,9-di-n-octylfluorenyl-2,7-diyl)-alt-(benzo[2,1,3]thiadiazol-4,8-diyl)](F8BT), polymethyl methacrylate, selenium, selenium dioxide (SeO₂), silver acetate (AgAc), sulfur, tetramethylammonium hydroxide, cadmium chloride (CdCl₂), dimethylformamide (DMF), dimethyl sulfoxide (DMSO), oleic acid, triethylamine, trioctylphosphine (TOP), trioctylphosphine oxide (TOPO), zinc acetate (Zn(Ac)₂), acrylamide/N,N′-methylenebisacrylamide, ammonium persulfate (APS), tetramethylethylenediamine (TMEDA), poly(ethylene glycol) monothiol monomethyl ether 2 kDa, 1-isocyano-2-methoxyethane, N-methylformamide, acetone, hexane, diethyl ether, chloroform, tetrahydrofuran (THF), methanol, Dulbecco's Modified Eagle's Medium (DMEM) variants, fetal bovine serum (FBS), Hoechst dye, LabTek chambers, Influx Pinocytic Cell-Loading reagent, 3-(4,5-dimethylthiazol-2-yl)-2,5-diphenyltetrazolium bromide (MTT), and Milli-Q water, used as received.

### Representative Alkyl Syntheses for Comparative Materials

Representative alkyl syntheses included: cadmium behenate (Cd(BAc)₂) and cadmium myristate (Cd(MAc)₂) formation by neutralizing fatty acids with cadmium chloride (CdCl₂) in methanol/water and tetramethylammonium hydroxide (TMAH), isolating precipitates by filtration and drying; CdSeS cores from cadmium behenate (Cd(BAc)₂) 0.2 mmol, selenium dioxide (SeO₂) 0.1 mmol, sulfur (S) 0.1 mmol, 1,2-hexadecanediol (HDD) 0.4 mmol, and 1-octadecene (ODE) 5 mL at 230° C. for 5-10 minutes with oleic acid quench and standard purification; CdS using 1-dodecanethiol (DDT) by dissolving cadmium oxide (CdO) 0.1 mmol in oleic acid and ODE, injecting DDT in ODE 0.4 mL at 260° C. for 12 minutes, and purifying; CdS with elemental sulfur (S) from Cd(BAc)₂ 0.2 mmol and S 0.2 mmol at 230° C. for 15 minutes, transferring to chloroform with oleic acid and oleylamine, and multi-step solvent exchange and precipitation; PbS cores by reacting lead(II) acetate trihydrate 0.2 mmol with oleic acid 0.24 mL in ODE 5 mL, injecting bis(trimethylsilyl) sulfide ((TMS)₂S) 0.1 mmol at 130° C., quenching, and purifying; (CdSe)CdS nanorods prepared via trioctylphosphine selenide (TOPSe) injection at 380° C. into trioctylphosphine oxide (TOPO)/octadecylphosphonic acid (ODPA)/CdO melts, purification, and CdS rod growth at 350° C. with trioctylphosphine sulfide (TOPS) feed, rapid quench, and repeated precipitation; CdSe nanoplatelets grown from CdO, oleic acid, and ODE at ˜220° C., with selenium (Se) addition and cadmium acetate (Cd(Ac)₂) at 190° C., 10 minute growth at 240° C., oleic acid quench, and size-selective precipitation to isolate 4-monolayer (4 ML) nanoplatelets (NPLs).

### Selenourea and Thiourea Preparation

In certain representative alkoxy syntheses with methoxy termini, selenourea and thiourea reagents were prepared by reacting selenium or sulfur (3.0 mmol) with (2-methoxyethyl)methylamine (3.0 mmol) and 1-isocyano-2-methoxyethane (3.0 mmol) in toluene (3 mL) at 100° C. for 1 hour under nitrogen, followed by filtration through polytetrafluoroethylene (PTFE) membrane filters (0.2 μm), evacuation for 24 hours, and characterization by proton nuclear magnetic resonance (¹H NMR) and high-resolution mass spectrometry (HRMS). A cadmium precursor was prepared by dissolving cadmium oxide (CdO) in poly(ethylene glycol) monoacid monomethyl ether (2a) and poly(ethylene glycol) dimethyl ether (3c) as listed in Table 7 and shown in FIG. 1 at 210° C., then degassing at 100° C. for 1 hour and storing under an inert atmosphere.

### Synthesis of N,N′-di(2-methoxyethyl)-N-methylselenourea

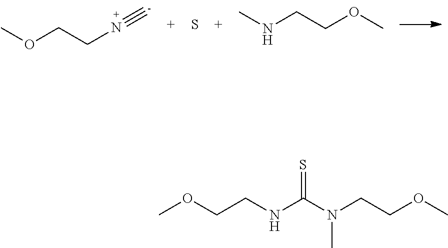

### Synthesis of N,N′-di(2-methoxyethyl)-N-methylthiourea

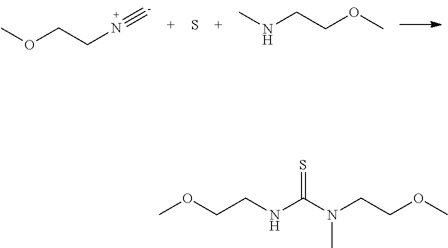

### Thiourea-Driven CdZnS Shell Growth in Alkoxy Media

A thiourea sulfur solution was prepared using N,N′-di(2-methoxyethyl)-N-methylthiourea with solvent 3e, vortexed for 5 minutes, degassed, and maintained under nitrogen. CdZnS shell growth with the thiourea precursor used CdSe cores (75 nmol), ligand 1a (0.2 mmol), ligand 2a (0.25 mmol), chloroform (0.2 mL), solvent 3a (2 mL), and solvent 3e (1 mL). The mixture was degassed at 100° C., followed by syringe-pump addition of a cadmium-ligand solution (Cd-2a) and the thiourea precursor at 3 mL h⁻¹ from 160° C. to 170° C. to add 0.8 monolayers (ML) of CdS, a 15 minute anneal, and subsequent 0.8 ML layers with +10° C. steps to 200° C. Zinc acetate (Zn(Ac)₂) was introduced for 1 ML of ZnS, with a 100° C. degas, 200° C. injection of the thiourea sulfur precursor, a 15 minute anneal, cooling, and repetition to build shells, typically 4 ML CdS and 2 ML ZnS. CdSeS cores were overgrown by the thiol route with 1.6 ML CdS and 1 ML ZnS. PbS cores were shell-grown at 120° C. with ligand 1a (0.2 mmol) and solvent 3a, using continuous sulfur feed for colloidal stability, yielding CdS by cation exchange; no ZnS was added.

Nanorods and nanoplatelets (NPLs) were overgrown at 220° C. with cadmium acetate (Cd(Ac)₂) and thiol-based sulfur feeds as above. Ag₂S, Cu₂S, and PbS cores were generated from the corresponding metal acetates with ligand 2a and solvent 3a, degassed at 100° C., heated to 150-180° C., injected with a sulfur solution (0.2 mL) containing ligand 1a, allowed brief growth at 110-170° C., cooled, and purified by nonpolar precipitation. CdS cores synthesized with the thiourea precursor used ligand 1a (0.2 mmol), solvent 3c (3 mL), and thiourea (0.1 mmol), degassed at 100° C., followed by injection of a cadmium chloride solution containing ligand 1a and solvent 3c at 190° C., growth at 170° C. for 30 minutes, and nonpolar precipitation.

Ag₂Se cores were made from silver acetate (AgAc, 0.05 mmol), ligand 1a (0.2 mmol), ligand 2a (1 mmol), and solvent 3c (3 mL), degassed, followed by injection of a selenourea solution (0.1 mmol) in solvent 3c (0.3 mL) at 120° C., rapid quench by adding solvent 3c (2 mL), and nonpolar precipitation. PbSe cores used lead(II) oxide (PbO, 0.1 mmol) dissolved in ligand 2a and solvent 3c at 180° C., isolated and re-dissolved with additional ligand 2a and solvent 3c, degassed, followed by injection of a selenourea solution (0.15 mmol) with ligand 1a and solvent 3c at 125° C., rapid quench, and nonpolar precipitation.

### Polar-Terminated Alkoxy Reaction Protocols and Oxide Formation

Example alkoxy syntheses with polar termini used cadmium oxide (CdO, 2 mmol) and ligand 2b (3 mL), heated to 220° C. under vacuum until clear and colorless, cooled to 100° C., followed by addition of tetraethylene glycol (solvent 3b, 17 mL), evacuation for 60 minutes, nitrogen backfill, and cooling to room temperature to form 0.1 M Cd solutions; analogous Zn solutions used zinc acetate (Zn(Ac)₂). A 0.15 M sulfur solution was made by mixing ligand 1c (35%) and ligand 1b (65%) in ligand 2b under nitrogen. CdZnS shells on CdSe cores used cores (75 nmol), ligand 1b (0.12 mmol), ligand 1c (0.08 mmol), chloroform (0.5 mL), solvent 3b (3 mL), ligand 2b (1 mL), degas at 100° C., then syringe-pump addition of Cd and S solutions at 0.6 mL h⁻¹ while heating at ˜15° C. min⁻¹ to 210° C. for 0.8 monolayers (ML) CdS, 5 minutes stir, continued additions at 220° C. to target thickness, then Zn precursor substitution to add ZnS layers; 4 ML CdS and 2 ML ZnS were grown. ZnO and CdO nanocrystals were prepared by melting zinc acetate (Zn(Ac)₂) or cadmium oxide (CdO, 2 mmol) with ligand 2b (5 mmol) at 220° C. under vacuum to a clear melt, backfilling nitrogen, injecting solvent 3b (7 mL), collecting aliquots, and cooling. Aqueous and nonpolar precipitation and filtration matched the methoxy-terminated workflows. Fourier Transform Infrared (FT-IR) time-course monitored mixtures of CdO, ligand 2b, and solvent 3b at 220° C., showing rapid ester formation and depletion of acids and hydroxyls.

### Phase Transfer and Alternate Aqueous Coatings

In certain implementations, phase transfer from nonpolar to aqueous for NC-2a used tetramethylammonium hydroxide (TMAH) in N-methylformamide (NMF) to move nanocrystals from hexane to NMF, followed by a 5000-fold molar excess of thiol ligands (1a, 1b, 1c, or 2 kDa variant of 1a) at 60° C. under nitrogen. Products were precipitated with hexane (or ether for 1b/1c coatings), dispersed in 50 mM sodium borate pH 8.5, and used immediately for GPC (gel permeation chromatography), zeta (zeta potential), and cellular imaging; samples for FT-IR (Fourier transform infrared spectroscopy), XPS (X-ray photoelectron spectroscopy), and NMR (nuclear magnetic resonance) were purified by 100 kDa centrifugal filtration in water and lyophilized.

NC-2b used P-IM-N3 polymer (polyacrylamido(histamine-co-triethyleneglycol-co-azidotriethylene-glycol)): alkyl nanocrystals (9 nmol) in hexane (3 mL) were phase transferred to N-methylformamide (NMF) with tetramethylammonium hydroxide (TMAH), solvents removed, then 1 nmol nanocrystals were mixed in dimethyl sulfoxide (DMSO) with P-IM-N3 (10 mg mL⁻¹), purged with nitrogen, reacted at 110° C. for 1 hour, precipitated with ether/chloroform 5:2 v/v, dispersed in 50 mM sodium borate at pH 8.5, and purified by 50 kDa filtration. NC-2c used amphipol (40%-octylamine-modified polyacrylic acid): chloroform nanocrystals (1 μM) were treated with amphipol in chloroform to a 2000-fold molar excess, solvent evaporated under vacuum overnight, sodium hydroxide (NaOH, 10 mM) added at 3 mL per nmol, dispersed, centrifuged at 7000 g for 20 minutes, purified by 100 kDa filtration with sodium borate at pH 8.5, and by gel permeation chromatography (GPC) in phosphate-buffered saline (PBS).

### Fabrication of Polymer and Hydrogel Nanocrystal Composites

Nanocrystal-polymer composites were prepared by mixing chloroform dispersions with polymers, polymethacrylate, poly(3-hexylthiophene-2,5-diyl) (P3HT), and poly[(9,9-di-n-octylfluorenyl-2,7-diyl)-alt-(benzo[2,1,3]thiadiazol-4,8-diyl)](F8BT)) at a 1:100 w/w nanocrystal:polymer ratio, vortexing, and spin coating at 500 rpm on glass, then imaging by confocal fluorescence microscopy. Hydrogel composites used acrylamide/bisacrylamide solutions, ammonium persulfate (APS), water, and tetramethylethylenediamine (TMEDA) to form gels after mixing with nanocrystal tetrahydrofuran (THF) dispersions and casting, then confocal imaging.

### Cytotoxicity Assay Conditions

Cytotoxicity of ligands and solvents was assayed by MTT in HeLa cells seeded at 10,000 cells per well, treated in PBS pH 7.4 at 37° C. for 24 hours, incubated with MTT to 0.5 mg/mL for 4 hours, dissolved in DMSO 100 μL for 15 minutes at 37° C., and read at 570 nm.

### Instrumentation Settings and Data Acquisition Parameters

Instrumental parameters included ¹H NMR (proton nuclear magnetic resonance) on a Bruker 600 MHz spectrometer with CDCl₃ (deuterated chloroform); DOSY (diffusion-ordered spectroscopy) on an Agilent VNMRS 750 using the DgsteSL_cc sequence with 2 ms trim, 7485 Hz spectral width, 2 ms diffusion gradient time, 50.0 ms delay, and 16 gradient levels from 2.79 to 60.03 G cm⁻¹; X-ray photoelectron spectroscopy (XPS) on a PHI VersaProbe 5000 or Kratos Axis Supra+ with Al Kα radiation (1486 eV), sulfur bands fit with Gaussian-Lorentzian functions (30% Lorentzian) in CasaXPS, C is at 284.8 eV as the reference, and spin-orbit constraints of 2:1 intensity and 1.18 eV splitting; FT-IR (Fourier transform infrared spectroscopy) on a PerkinElmer Spectrum 100; optical spectroscopy on a Horiba NanoLog and Agilent Cary 5000; quantum yield (QY) referenced to fluorescein (in aqueous 0.1 M NaOH, Quantum Yield=92%) with 491 nm excitation; TEM (transmission electron microscopy) on a JEOL 2100 CRYO; dynamic light scattering (DLS) and zeta potentiometry (zeta potential measurement) on a Malvern Zetasizer with number-based distributions and a DTS1070 cell in 10 mM sodium borate at pH 8.5; GPC (gel permeation chromatography) on a Superose 6 column with PBS (phosphate-buffered saline) at 0.5 mL min⁻¹ and protein standards; colloidal stability monitored by daily absorbance of NC-1 and NC-2a at 5 μM in water or PBS at pH 7.4 for one month at room temperature in the dark.

### Density Functional Theory (DFT) Slab Construction and Computational Parameters

DFT slab construction used CdS zinc blende unit cells with a Cd—S bond length of 2.55 Å, {111}truncation, 12 Å vacuum per side, and 6 monolayers (Cd₂₄S₂₄). The slabs had Cd-terminated (111) and S-terminated (1̅1̅1̅) facets, pseudo-hydrogen passivation at 0.5 e⁻ and 1.5 e⁻ as appropriate, and a compensating background charge when needed. Structural relaxation proceeded to forces less than 50 meV Å⁻¹, with DFT-D3 (density functional theory with Grimme's D3 dispersion) corrections, a 2×2×1 Γ-centered k-point grid, a VASP (Vienna Ab initio Simulation Package) plane-wave cutoff of 450 eV, PAW (projector augmented wave) potentials for H (1s¹), C (2s²2p²), S (2s²2p⁴), and Cd (4d¹⁰5s²), PBE GGA (Perdew-Burke-Ernzerhof generalized gradient approximation) exchange-correlation, and dipole corrections for CH₃SH (methanethiol) and CH₃S-(methanethiolate) molecules. Binding and core-level Binding and core-level energies were computed as defined above and normalized with core-level shifts.

The present disclosure may be understood more readily by reference to the above detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

In certain embodiments, the term “about” may allow for deviations from each endpoint of a stated range by a relative percentage, such as, but not limited to, from 0.1% to 25%, from 0.1% to 15%, from 0.1% to 10%, from 0.1% to 5%, from 0.1% to 1%, from 0.1% to 0.5%, from 0.5% to 25%, from 1% to 25%, from 5% to 25%, from 10% to 25%, from 15% to 25%, from 0.5% to 15%, from 1% to 10%, or any combination thereof. For example, a range stated as “about 50 to about 100” may include values from 49.5 to 100.5 (if a 1% variation is applied), or from 37.5 to 112.5 (if a 25% variation is applied), depending on the context and the precision required for a particular embodiment. Unless otherwise specified, the use of “about” in connection with a numerical value or range should be interpreted as including the stated value or range and minor variations as described above, provided that such variations do not materially alter the intended function or result of the invention.

Unless otherwise explained, all technical and scientific terms used herein have the same meaning as commonly understood by one of ordinary skill in the art to which a disclosed disclosure belongs. The singular terms “a,” “an,” and “the” include plural referents unless context clearly indicates otherwise. Similarly, the word “or” is intended to include “and” unless the context clearly indicates otherwise. “Comprising” means “including”; hence, “comprising A or B” means “including A” or “including B” or “including A and B.” All references cited herein are incorporated by reference.

The disclosure may be further understood by the above non-limiting examples. All references cited herein are hereby incorporated by reference to the extent not inconsistent with the disclosure herewith. Although the description herein contains many specificities, these should not be construed as limiting the scope of the disclosure but as merely providing illustrations of some of the presently preferred embodiments of the disclosure. For example, thus the scope of the disclosure should be determined by the appended aspects and their equivalents, rather than by the examples given.

While the present disclosure can take many different forms, no limitation of the scope of the disclosure is intended. Any alterations and further modifications of the described embodiments, and any further applications of the principles of the disclosure as described herein are contemplated as would normally occur to one skilled in the art to which the disclosure relates.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure. Thus, it should be understood that although the present disclosure has been specifically disclosed by preferred embodiments, exemplary embodiments and optional features, modification and variation of the concepts herein disclosed may be resorted to by those skilled in the art, and that such modifications and variations are considered to be within the scope of this disclosure as defined by the appended aspects. The specific embodiments provided herein are examples of useful embodiments of the present disclosure and it will be apparent to one skilled in the art that the present disclosure may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Many of the molecules disclosed herein contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this disclosure for a given application. In specific applications, the selection of a given anion or cation for preparation of a salt may result in increased or decreased solubility of that salt.

Every formulation or combination of components described or exemplified herein can be used to practice the disclosure, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the aspects herein.

All patents and publications mentioned in the specification are indicative of the levels of skill of those skilled in the art to which the disclosure pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are disclosed, it should be understood that compounds known and available in the art prior to Applicant's disclosure, including compounds for which an enabling disclosure is provided in the references cited herein, are not intended to be included in the composition of matter aspects herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect, including but not limited to, yielding broadly dispersible nanocrystals, affording surfaces with elevated-temperature colloidal stability, greener aqueous purification workflows, or any combination thereof. In each instance herein any of the terms “comprising”, “consisting essentially of” and “consisting of” may be replaced with either of the other two terms. The disclosure illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the disclosure without resort to undue experimentation. All art-known functional equivalents, of any such materials and methods are intended to be included in this disclosure. The terms and expressions which have been employed are used as terms of description and not of limitation, and there is no intention that in the use of such terms and expressions of excluding any equivalents of the features shown and described or portions thereof, but it is recognized that various modifications are possible within the scope of the disclosure. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this disclosure as defined by the appended aspects.

Although the present disclosure has been described with reference to certain embodiments thereof, other embodiments are possible without departing from the present disclosure. The spirit and scope of the appended aspects should not be limited, therefore, to the description of the preferred embodiments contained herein. All embodiments that come within the meaning of the aspects, either literally or by equivalence, are intended to be embraced therein. Furthermore, the advantages described above are not necessarily the only advantages of the disclosure, and it is not necessarily expected that all of the described advantages will be achieved with every embodiment of the disclosure.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

1. A method of making nanocrystals, the method comprising:
providing a reaction system, the reaction system comprising:
at least one metal precursor,
at least one alkoxy ligand, and
at least one alkoxy solvent; and
heating the reaction system to a temperature from about 100° C. to about 380° C. to form the nanocrystals.

2. The method of claim 1, wherein, once formed, the nanocrystals are dispersible at room temperature in a solvent having a room temperature dielectric constant (F) from about 2.4 to about 182.

3. The method of claim 1, wherein the reaction system further comprises a chalcogen precursor.

4. The method of claim 3, wherein the chalcogen precursor is selected from selenium, selenium dioxide, sulfur, bis(trimethylsilyl) sulfide, a thiourea, and a selenourea.

5. The method of claim 4, wherein the selenourea comprises N,N′-di(2-methoxyethyl)-N-methylselenourea.

6. The method of claim 4, wherein the thiourea comprises N,N′-di(2-methoxyethyl)-N-methylthiourea.

7. The method of claim 3, wherein the chalcogen precursor is the same as the alkoxy ligand and is poly(ethylene glycol) monothiol monohydroxy or poly(ethylene glycol) monothiol monomethyl ether.

8. The method of claim 1, wherein the metal precursor is selected from cadmium acetate, cadmium oxide, cadmium chloride, cadmium myristate, cadmium behenate, lead(II) acetate trihydrate, lead(II) chloride, lead oxide, lead(II) acetate, silver acetate, copper acetate, zinc acetate, zinc oxide, and cadmium chloride monohydrate.

9. The method of claim 1, wherein the alkoxy ligand comprises an oligo(ethylene glycol) compound, polyethylene glycol, ethylene glycol, propylene glycol, a dihydroxy-terminated triethylene glycol, and a dimethoxy-terminated triethylene glycol.

10. The method of claim 9, wherein the oligo(ethylene glycol) compound is terminated with a functional group selected from methoxy, alcohol, thiol, amine, carboxylic acid, phosphonic acid, phosphoric acid, and phosphine.

11. The method of claim 1, wherein the alkoxy ligand is selected from poly(ethylene glycol) monothiol monomethyl ether, poly(ethylene glycol) monothiol monoacid, poly(ethylene glycol) monothiol monohydroxy, poly(ethylene glycol) monoacid monomethyl ether, poly(ethylene glycol) diacid, and α-hydroxy-ω-propionic acid tetraethylene glycol.

12. The method of claim 1, wherein the alkoxy solvent is selected from a tertiary amine alkoxy solvent and a dihydroxy alkoxy solvent.

13. The method of claim 1, wherein the alkoxy solvent is selected from tris[2-(2-methoxyethoxy)ethyl]amine, tetraethylene glycol, poly(ethylene glycol) dimethyl ether, poly(ethylene glycol) monohydroxy monomethyl ether, and poly(propylene glycol) mono-2-aminopropyl monomethoxyethyl.

14. The method of claim 2, wherein the nanocrystals are quantum dots having a quantum yield from about 10% to about 80% when dispersed in the solvent.

15. The method of claim 1, wherein the nanocrystals comprise CdSe, CdS, CdSeS, PbS, PbSe, Ag₂S, Cu₂S, Ag₂Se, ZnO, CdO, CdSe nanoplatelets, (CdSe)CdS nanorods, (CdSe)CdZnS core/shell nanocrystals, (CdSe)ZnSe core/shell nanocrystals, (CdSe)CdZnSe core/shell nanocrystals, (CdSeS)CdS core/shell nanocrystals, (PbS)CdS core/shell nanocrystals, or any combination thereof.

16. The method of claim 1, further comprising growing a shell on the nanocrystals, the shell selected from CdS, ZnS, ZnSe, CdZnS, CdZnSe, or combinations thereof.

17. The method of claim 1, wherein the nanocrystals have cores comprising CdS, Cu₂S, Ag₂S, PbS, Ag₂Se, PbSe, CdSe, CdSeS, or combinations thereof.

18. The method of claim 1, wherein the reaction system comprises a methoxy-terminated alkoxy ligand and a methoxy-terminated alkoxy solvent.

19. The method of claim 1, wherein the reaction system comprises a polar-terminated alkoxy ligands and a dihydroxy-terminated alkoxy solvent.

20. The method of claim 1, wherein the nanocrystals have a diameter from about 2 nm to about 20 nm.
